(19) United States
(12) Patent Application Publication
(10) Pub. No.: US 2024/0421950 A1
(43) Pub. Date: Dec. 19, 2024

(54) NON-COHERENT COMBINING FOR FULL GRADIENTS TRANSMISSION IN FEDERATED LEARNING

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 18/186,911

(22) Filed: Mar. 20, 2023

(51) Int. Cl. H04L 5/00

(52) U.S. Cl. CPC H04L 5/0032; H04L 5/0037; H04L 5/0044

(57) ABSTRACT

A first UE may identify, in at least one round of a federated learning procedure, at least one gradient update based on local data and a local copy of a machine learning model associated with the federated learning procedure. The first UE may transmit, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update. Based on the non-coherent OTA aggregation scheme, the network node may obtain the combined gradients associated with all participating UEs by averaging the received power over the set of resources.

### INTRODUCTION

The present disclosure relates generally to communication systems, and more particularly, to transmission of gradient updates for federated learning in a wireless communication system.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method may include identifying, in at least one round of a federated learning procedure, at least one gradient update based on local data and a local copy of a machine learning model associated with the federated learning procedure. Additionally, the method may include transmitting, in the at least one round of the federated learning procedure, based on a non-coherent over-the-air (OTA) aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update.

In another aspect of the disclosure, an apparatus for wireless communication is provided. The apparatus may be a UE that includes a memory and at least one processor coupled to the memory and configured to identify, in at least one round of a federated learning procedure, at least one gradient update based on local data and a local copy of a machine learning model associated with the federated learning procedure. Additionally, the memory and the at least one processor may be configured to transmit, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update.

In another aspect of the disclosure, an apparatus for wireless communication at a UE is provided. The apparatus may include means for identifying, in at least one round of a federated learning procedure, at least one gradient update based on local data and a local copy of a machine learning model associated with the federated learning procedure. Additionally, the example apparatus may include means for transmitting, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update.

In another aspect of the disclosure, a non-transitory computer-readable storage medium storing computer executable code for wireless communication at a UE is provided. The code, when executed, may cause a processor to identify, in at least one round of a federated learning procedure, at least one gradient update based on local data and a local copy of a machine learning model associated with the federated learning procedure. Additionally, the example code, when executed, may cause the processor to transmit, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update.

In an aspect of the disclosure, a method of wireless communication at a network node is provided. The method may include receiving, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. Additionally, the method may include identifying, in the at least one round of the federated learning procedure, the at least one combined gradient update based on the energy associated with the plurality of sequences averaged over the set of resources. Additionally, the method may include updating, in the at least one round of the federated learning procedure, a machine learning model associated with the federated learning procedure based on the at least one combined gradient update.

In another aspect of the disclosure, an apparatus for wireless communication is provided. The apparatus may be a network node that includes a memory and at least one processor coupled to the memory and configured to receive, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. Additionally, the memory and the at least one processor may be configured to identify, in the at least one round of the federated learning procedure, the at least one combined gradient update based on the energy associated with the plurality of sequences averaged over the set of resources. Additionally, the memory and the at least one processor may be configured to update, in the at least one round of the federated learning procedure, a machine learning model associated with the federated learning procedure based on the at least one combined gradient update.

In another aspect of the disclosure, an apparatus for wireless communication at a network node is provided. The apparatus may include means for receiving, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. Additionally, the example apparatus may include means for identifying, in the at least one round of the federated learning procedure, the at least one combined gradient update based on the energy associated with the plurality of sequences averaged over the set of resources. Additionally, the example apparatus may include means for updating, in the at least one round of the federated learning procedure, a machine learning model associated with the federated learning procedure based on the at least one combined gradient update.

In another aspect of the disclosure, a non-transitory computer-readable storage medium storing computer executable code for wireless communication at a network node is provided. The code, when executed, may cause a processor to receive, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. Additionally, the example code, when executed, may cause the processor to identify, in the at least one round of the federated learning procedure, the at least one combined gradient update based on the energy associated with the plurality of sequences averaged over the set of resources. Additionally, the example code, when executed, may cause the processor to update, in the at least one round of the federated learning procedure, a machine learning model associated with the federated learning procedure based on the at least one combined gradient update.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2 is a diagram illustrating an example of a wireless communication system and an access network, in accordance with various aspects of the present disclosure.

FIG. 3A is a diagram illustrating an example of a first frame, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink (UL) channels within a subframe, in accordance with various aspects of the present disclosure.

FIG. 4 is a diagram illustrating an example of a base station and user equipment (UE) in an access network, in accordance with various aspects of the present disclosure.

FIG. 5 is a diagram illustrating aspects of machine learning (ML) in wireless communication, in accordance with various aspects of the present disclosure.

FIG. 6 illustrates example aspects of machine learning, in accordance with various aspects of the present disclosure.

FIG. 7 is a communication diagram showing example aspects of federated learning (FL) at a wireless network, in accordance with various aspects of the present disclosure.

FIG. 8 is a diagram of an example environment associated with federated learning according to one or more aspects, in accordance with various aspects of the present disclosure.

FIG. 9 is a diagram of an example environment associated with federated learning according to one or more aspects, in accordance with various aspects of the present disclosure.

FIG. 10 is a diagram illustrating an example resource configuration for non-coherent OTA aggregation, in accordance with various aspects of the present disclosure.

FIG. 11 is a diagram illustrating an example resource configuration for non-coherent OTA aggregation, in accordance with various aspects of the present disclosure.

FIG. 12 is a diagram of a communication flow of a method of wireless communication.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a flowchart of a method of wireless communication, in accordance with various aspects of the present disclosure.

FIG. 17 is a diagram illustrating an example of a hardware implementation for an example apparatus and/or UE, in accordance with various aspects of the present disclosure.

FIG. 18 is a diagram illustrating an example of a hardware implementation for an example network entity, in accordance with various aspects of the present disclosure.

### DETAILED DESCRIPTION

Some wireless communication may be based on a machine learning model. In some aspects, a global machine learning model may be maintained at a network entity, such as a network parameter server (which may be provided at a network node, such as a base station, a component of a base station, connected to multiple base stations, a component of a core network, etc., and which may also be referred to as an edge server). In federated learning, a group of UEs may cooperate to assist in training the global machine learning model at the network parameter server. Each UE may collect its own local dataset (e.g., data collected by an individual UE, which may be referred to as a private dataset) based on a local copy of the machine learning model. A local copy may refer to a version of the global machine learning mode that is stored at the UE. Each of the UEs may share information with the network without sharing the actual local dataset. A federated learning procedure may refer to a process in which multiple rounds or iterations of information sharing occur between the UEs and the network, which may be referred to interchangeably as a federated learning round, a communication round, or a feedback round. In each round/iteration of dataset sharing, the network parameter server may broadcast a global training parameter vector (e.g., including weights for the parameters of the global ML model) to the UEs participating in the iteration/round. Each participating UE may then estimate one or more gradients relative to the parameters of the ML model (also referred to as gradient updates) that may minimize the loss function on a batch of data in the local dataset of the UE. A gradient may refer to the direction and magnitude of change of a function, such as an ascent or descent of a function. The gradient may be considered a generalization of a derivative of a function, e.g., enabling a prediction of an effect due to a change. For example, the gradient may measure the change in weights with regard to a change in error and help to assess accuracy with each iteration of parameter updates. In the training process, gradients of a loss function with respect to the weights of the ML model may be used to update the weights. Thereafter, each participating UE may transmit information about the local gradients to the parameter server. The parameter server may combine the local gradients to obtain a global (combined) gradient set and to update the global training parameter vector using the estimated global gradient set. If the global ML model does not converge (e.g., if there is any non-zero or non-negligible update to the global training parameter vector), another iteration/round may be performed. For the next iteration/round, the parameter server may broadcast the updated global training parameter vector to the UEs participating in the next iteration/round and receive gradient information from the UEs relative to the updated global training parameter vector. One or more iterations/rounds may be performed until the global ML model at the parameter server converges. By providing gradient information rather than the actual collected dataset at the UE, each UE is able to maintain the privacy of the UE's collected dataset while helping to train the machine learning model at the network parameter server. The collection and use of the gradient information from multiple UEs improves efficiency in training the global model at the network parameter server.

Aspects presented herein provide a non-coherent combining scheme that enables each UE to send full gradients relative to the parameters of the ML model for model training of a global machine learning model at a network parameter server. One or more aspects presented herein enable the gradient information to be sent by the UEs without channel state information (CSI) or with limited CSI at the UE. By enabling the UE to send the gradient information without performing channel pre-compensation, one or more aspects presented herein allow for the UE to send the gradient information to the network even when CSI is not available at the UE. Channel pre-compensation may refer to a technique for compensating for distortion and interference caused by the wireless channel by applying an inverse distortion to the transmitted signal at the transmitter. As well, one or more aspects presented herein provide added power savings at the UE, because channel pre-compensation involves additional transmission power at the UE. As presented herein, according to one or more aspects, the network may configure each UE to send federated learning updates by scaling the power of the symbols in a random sequence to be proportional, in part, to the gradient values. Then, rather than transmitting the actual gradient values using a coherent transmission scheme (with channel pre-compensation), the UE may transmit a sequence (e.g., a random sequence or pseudo-random sequence) using a scaled power that is proportional to the gradient value and a pathloss. A pathloss may refer to a reduction in power density of an electromagnetic wave as it propagates through space and may also be referred to as attenuation. A sequence may refer to an ordered set of symbols or bits. The use of the scaled transmission power enables the network to receive transmissions of gradient information from multiple UEs for a corresponding federated learning parameter non-coherently on a same set of resources.

In one example, before or at the start of the federated learning procedure, the first UE may transmit an indication of one or more UE capabilities of the first UE associated with the non-coherent OTA aggregation scheme to the parameter server. Accordingly, the first UE may report the power scaling schemes supported by the first UE to the parameter server.

In one example, before or at the start of the federated learning procedure, the parameter server may transmit one or more configurations associated with the non-coherent OTA aggregation scheme to the first UE via at least one of a radio resource control (RRC) message, a medium access control-control element (MAC-CE), a system information (SI) message, or a downlink control information (DCI) message. Accordingly, the parameter server may provide a power scaling scheme. The power scaling scheme may be supported by the UEs participating in the federated learning procedure.

In one example, the one or more configurations associated with the non-coherent OTA aggregation scheme may include a quantization level configuration associated with the transmit power for the at least one sequence.

In one configuration, the transmit power for the at least one sequence may be proportional to the magnitude of the at least one gradient update.

In one configuration, the transmit power for the at least one sequence may be based at least in part on a sum of the magnitude of the at least one gradient update and an offset value. The transmit power may not be negative while the at least one gradient update may take a negative value. Accordingly, the offset value may convert the range of the at least one gradient update into a non-negative range.

In some configurations, the set of resources associated with the non-coherent OTA aggregation scheme may include a first subset of resources and a second subset of resources. The first UE may transmit the at least one sequence via the first subset of resources in response to the at least one gradient update being positive, and may transmit the at least one sequence via the second subset of resources in response to the at least one gradient update being negative. Accordingly, the use of the two separate subsets of resources may represent another way in which a UE may transmit a negative gradient with a non-negative transmit power.

In one example, the transmit power associated with the at least one sequence may be further based on a local batch size (i.e., the size of the local data batch used at the first UE to obtain the local gradient(s) at the first UE) associated with the first UE. Accordingly, for example, a UE with a larger local batch size may use a higher transmit power. Accordingly, based on the OTA aggregation, the local gradient(s) of the UE with the larger local batch size may be associated with a higher weight in the combined gradient(s).

In one example, the transmit power associated with the at least one sequence may be further based on a local learning weight associated with the first UE. For example, the local learning weight may be based on a local learning rate. Accordingly, based on the OTA aggregation, the local gradient(s) of the UE with higher local learning rate may be associated with a higher weight in the combined gradient(s).

In one example, the local learning weight associated with the first UE may be based on an assignment from the parameter server. Accordingly, the parameter server may control the weights associated with the local gradient(s) of the UEs on an individual UE basis by assigning appropriate local learning weights to the UEs.

In one example, the set of resources may span a configured (e.g., preconfigured) range in time and/or frequency. Accordingly, the parameter server may average out the small scale fading channels by averaging the received power across the set of resources.

In one example, the at least one sequence may be a pseudorandom sequence.

In one example, the transmit power associated with the at least one sequence may be further based on a pathloss associated with a channel for the first UE. Accordingly, the impact of the pathloss on the received power at the parameter server may be removed.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

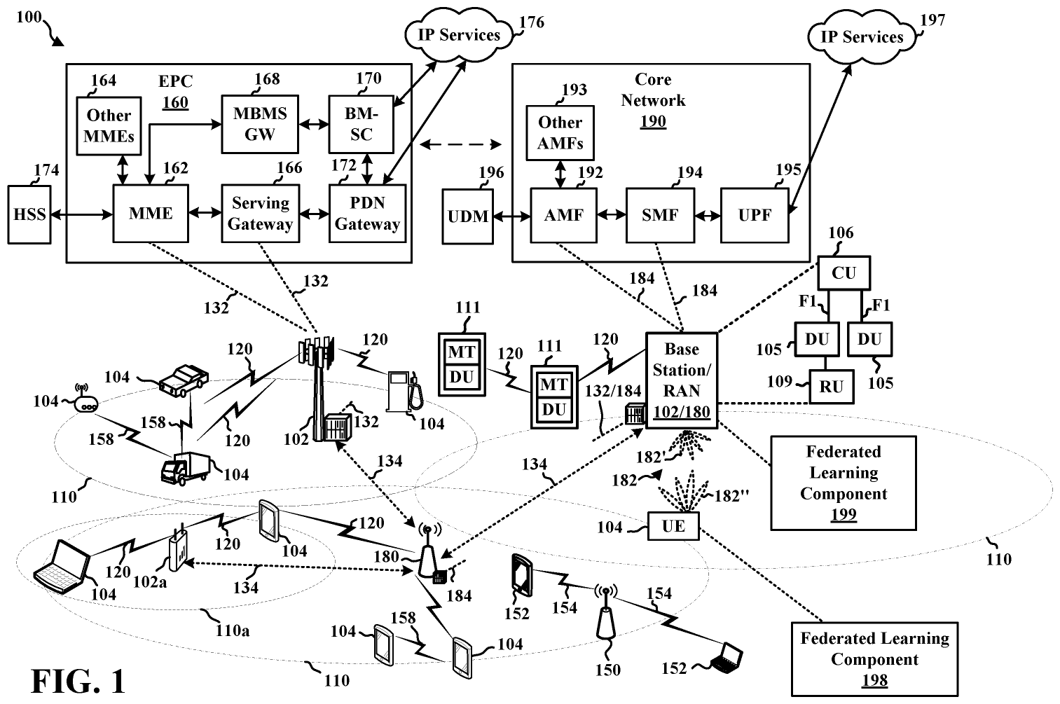

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) (e.g., an EPC 160), and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with the core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or the core network 190) with each other over third backhaul links 134 (e.g., an X2 interface). The first backhaul links 132, the second backhaul links 184 (e.g., an Xn interface), and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

An access network may include one or more integrated access and backhaul (IAB) nodes (e.g., the IAB nodes 111) that exchange wireless communication with a UE (e.g., one of the UEs 104) or another IAB node to provide access and backhaul to a core network. In an IAB network of multiple IAB nodes, an anchor node may be referred to as an IAB donor. The IAB donor may be a base station (e.g., one of the base stations 102 or one of the base stations 180) that provides access to the core network 190 or the EPC 160 and/or control to one or more of the IAB nodes 111. The IAB donor may include a CU 106 and a DU 105. The IAB nodes 111 may include a DU 105 and a mobile termination (MT). The DU 105 of an IAB node may operate as a parent node, and the MT may operate as a child node.

As described above, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

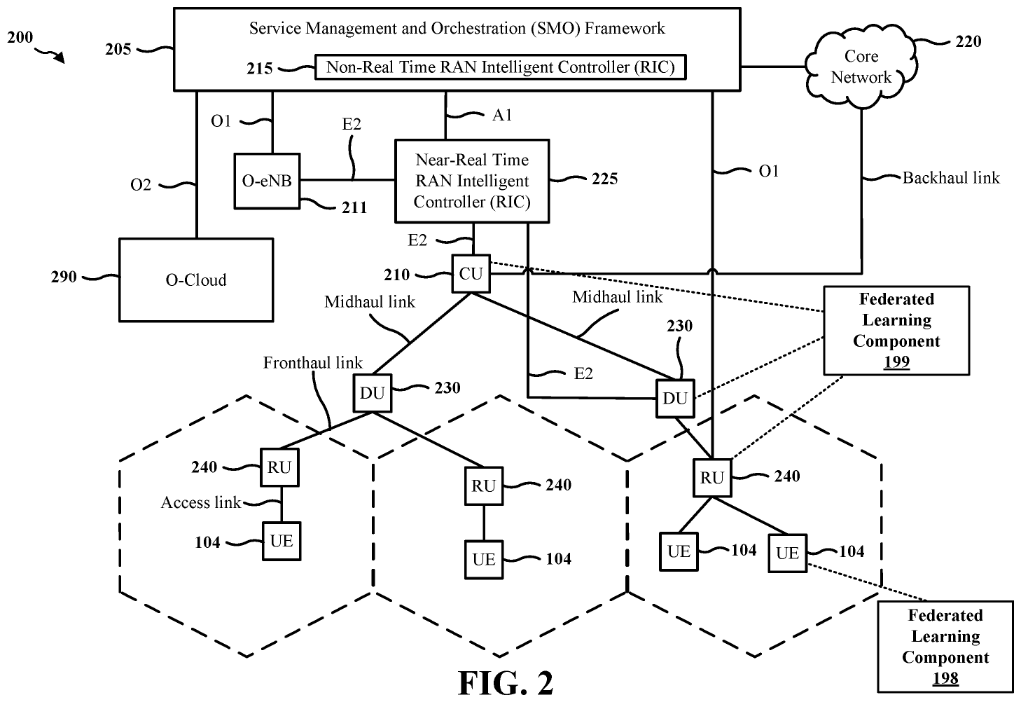

As an example, FIG. 2 shows a diagram illustrating architecture of an example disaggregated base station 200. The disaggregated base station 200 architecture may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). The CU 210 (e.g., the CU 106 of FIG. 1) may communicate with one or more DUs (e.g., a DU 230) via respective midhaul links, such as an F1 interface. A DU 230 (e.g., the DU 105 of FIG. 1) may communicate with one or more RUs (e.g., an RU 240) via respective fronthaul links. An RU 240 (e.g., the RU 109 of FIG. 1) may communicate with respective UEs (e.g., the UEs 104 of FIG. 1) via one or more radio frequency (RF) access links. In some implementations, a UE may be simultaneously served by multiple RUs.

Each of the units, i.e., the CU 210, the DU 230, the RU 240, as well as the Near-RT RIC 225, the Non-RT RIC 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) can be implemented to handle over the air (OTA) communication with one or more of the UEs 104. In some implementations, real-time and non-real-time aspects of control and user plane communication with the RU(s) can be controlled by the corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud 290 (O-Cloud)) to perform network element life cycle management (such as to instantiate virtualized network elements) via a cloud computing platform interface (such as an O2 interface). Such virtualized network elements can include, but are not limited to, the CU 210, the DU 230, the RU 240 and the Near-RT RIC 225. In some implementations, the SMO Framework 205 can communicate with a hardware aspect of a 4G RAN, such as an open eNB (O-eNB) (e.g., an O-eNB 211), via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

Referring again to FIG. 1, the base stations 102 may wirelessly communicate with the UEs 104. Each of the base stations 102 may provide communication coverage for a respective geographic coverage area (e.g., a coverage area 110). There may be overlapping geographic coverage areas. For example, a small cell 102a may have a coverage area 110a that overlaps the coverage area 110 of one or more of the base stations 102 (e.g., one or more macro base stations). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5 MHz, 10 MHz, 15 MHz, 20 MHz, 100 MHz, 400 MHz, etc.) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some of the UEs 104 may communicate with each other using device-to-device (D2D) communication link (e.g., a D2D communication link 158). The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi access point (AP) 150 in communication with Wi-Fi stations (STAs) (e.g., STAs 152) via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102a may operate in a licensed and/or an unlicensed frequency spectrum. When operating in an unlicensed frequency spectrum, the small cell 102a may employ NR and use the same unlicensed frequency spectrum (e.g., 5 GHz, or the like) as used by the Wi-Fi AP 150. The small cell 102a, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FRI characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 102a or a large cell (e.g., a macro base station), may include and/or be referred to as an eNB, gNodeB (gNB), or another type of base station. Some base stations, such as a gNB (e.g., one of the base stations 180) may operate in a traditional sub 6 GHz spectrum, in millimeter wave frequencies, and/or near millimeter wave frequencies in communication with the UEs 104. When the gNB operates in millimeter wave or near millimeter wave frequencies, the gNB may be referred to as a millimeter wave base station. The millimeter wave base station may utilize beamforming 182 with one or more of the UEs 104 to compensate for path loss and short range. The base stations 180 and the UEs 104 may each include a plurality of antennas, such as antenna elements, antenna panels, and/or antenna arrays to facilitate the beamforming.

The base stations 180 may transmit a beamformed signal to one or more of the UEs 104 in one or more transmit directions 182′. A UE may receive the beamformed signal from the base station in one or more receive directions 182″. The UE may also transmit a beamformed signal to the base station in one or more transmit directions. The base stations 180 may receive the beamformed signal from the UE in one or more receive directions. The base stations 180/the UEs 104 may perform beam training to determine the best receive and transmit directions for each of the base station/the UE. The transmit and receive directions for the base station may or may not be the same. The transmit and receive directions for the UE may or may not be the same.

The EPC 160 may include a Mobility Management Entity (MME) (e.g., an MME 162), other MMEs 164, a Serving Gateway 166, a Multimedia Broadcast Multicast Service (MBMS) Gateway (e.g., an MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. User Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) (e.g., an SMF 194), and a User Plane Function (UPF) (e.g., a UPF 195). The AMF 192 may be in communication with a Unified Data Management (UDM) (e.g., a UDM 196). The AMF 192 is the control node that processes the signaling between the UEs 104 and the core network 190. Generally, the AMF 192 provides QoS flow and session management. User Internet protocol (IP) packets are transferred through the UPF 195. The UPF 195 provides UE IP address allocation as well as other functions. The UPF 195 is connected to IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base stations 102 provide an access point to the EPC 160 or the core network 190 for the UEs 104. Examples of the UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UEs 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network, such as one of the UEs 104 in communication with a network entity, such as one of the base stations 102 or a component of a base station (e.g., a CU 106, a DU 105, and/or an RU 109), may be configured to participate in one or more aspects of a federated learning procedure. For example, one of the UEs 104 may include a federated learning component 198 configured to identify, in at least one round of a federated learning procedure, at least one gradient update based on local data and a local copy of a machine learning model associated with the federated learning procedure.

In certain aspects, the federated learning component 198 may be configured to transmit, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update.

In another configuration, a network entity, such as one of the base stations 102 or a component of a base station (e.g., a CU 106, a DU 105, and/or an RU 109), may be configured to perform one or more aspects of a federated learning procedure. For example, one of the base stations 102 may include a federated learning component 199 configured to receive, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme.

In certain aspects, the federated learning component 199 may be configured to identify, in the at least one round of the federated learning procedure, the at least one combined gradient update based on the energy associated with the plurality of sequences averaged over the set of resources. Additionally, the federated learning component 199 may be configured to update, in the at least one round of the federated learning procedure, a machine learning model associated with the federated learning procedure based on the at least one combined gradient update.

The aspects presented herein may enable the UEs participating in a federated learning round to share the full gradients with the parameter server without performing channel pre-compensation. The network node may obtain the combined gradients associated with the participating UEs, e.g., each participating UE or all participating UEs, by averaging the received power over the set of resources.

Although the following description provides examples directed to 5G NR, the concepts described herein may be applicable to other similar areas, such as LTE, LTE-A, CDMA, GSM, 6G, and/or other wireless technologies.

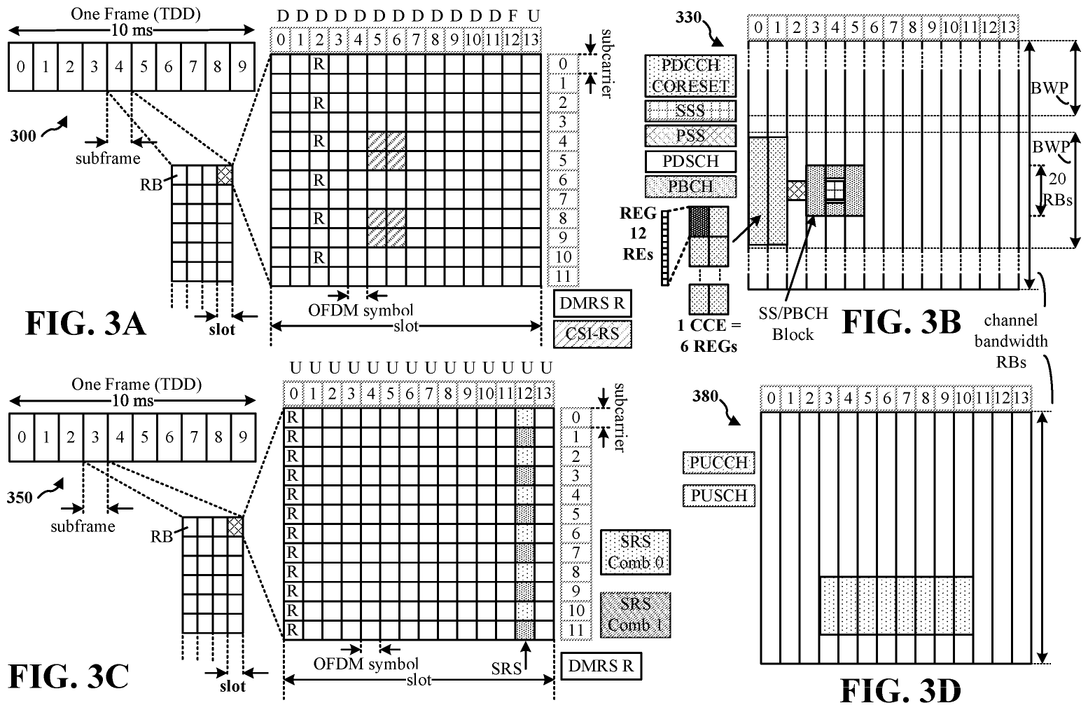

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD. Although an example frame structure is shown for 5G NR in order to illustrate the concept of a time and frequency resource structure, the concepts described herein may be applicable to other wireless technologies, such as LTE, LTE-A, CDMA, GSM, 6G, and/or other wireless technologies.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δƒ = 2^{μ} • 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE (e.g., one of the UEs 104 of FIG. 1) to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

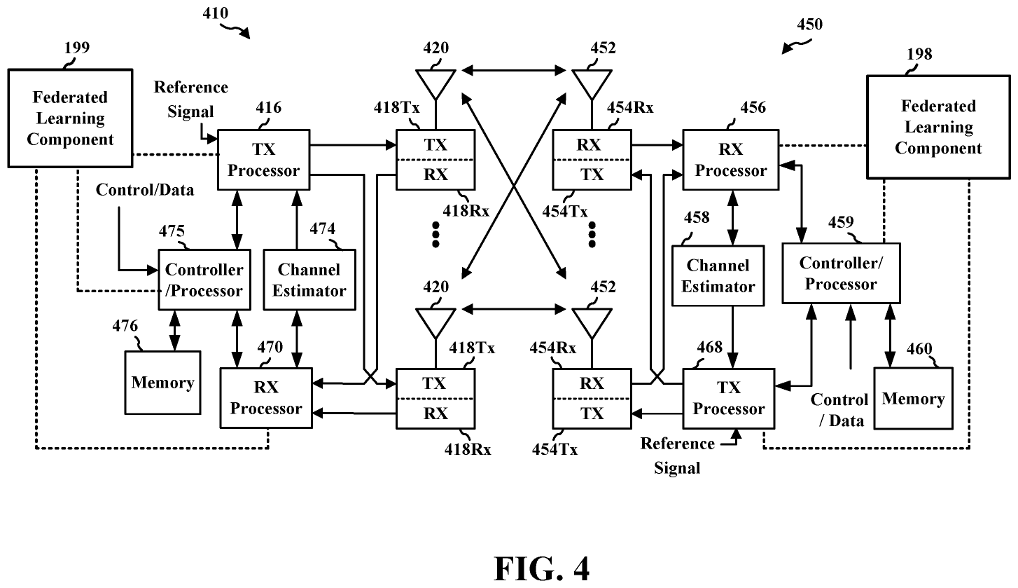

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and memory 476. The example UE 450 includes antennas 452, a transmitter 454Tx, a receiver 454Rx, an RX processor 456, a channel estimator 458, a controller/processor 459, memory 460, and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ. priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ. priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the federated learning component 198 of FIG. 1.

At least one of the TX processor 416, the RX processor 470, and the controller/processor 475 may be configured to perform aspects in connection with the federated learning component 199 of FIG. 1.

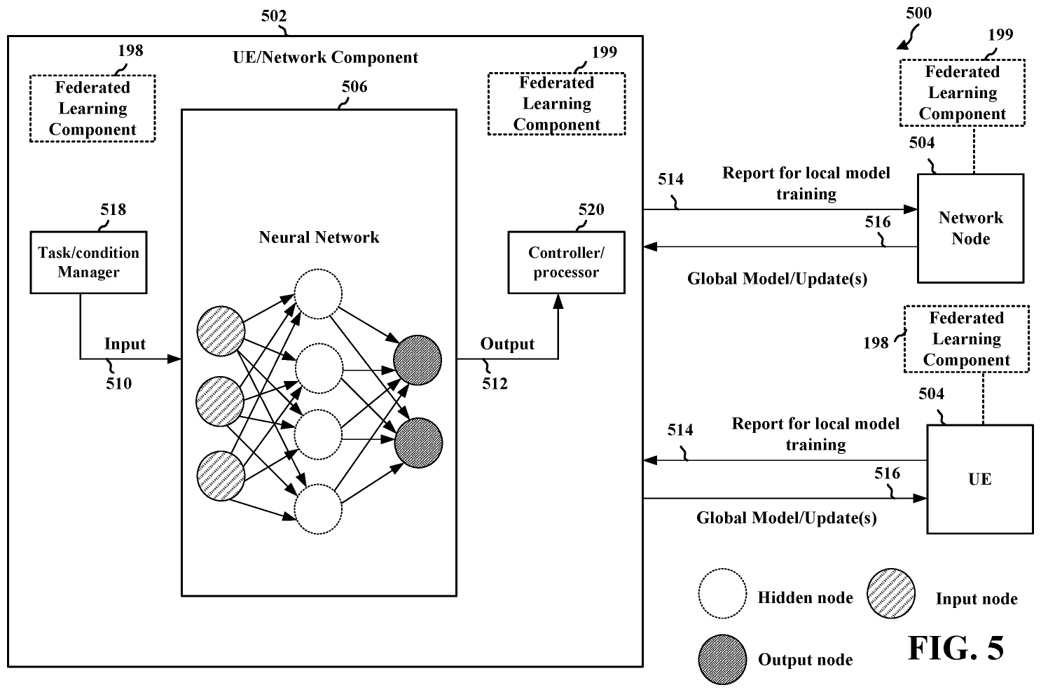

FIG. 5 illustrates a diagram 500 of a first wireless communication device (e.g., first wireless device 502) that includes a neural network 506 configured for determining communications with a second device 504. In some aspects, the neural network 506 may be included in a UE. The first wireless device 502 may be a UE, and the second device 504 may correspond to a second UE, a base station, or other network component, such as a core network component. In some aspects, the neural network 506 may be included in a network component. The first wireless device 502 may be one network component, and the second device 504 may be a second network component. A UE and/or a base station (e.g., including a (CU) and/or a distributed unit (DU)) may use machine-learning algorithms, deep-learning algorithms, neural networks, reinforcement learning, regression, boosting, or advanced signal processing methods for aspects of wireless communication, e.g., with a base station, a TRP, another UE, etc. The CU may provide higher layers of a protocol stack, such the SDAP. PDCP, RRC, etc., while the DU may provide lower layers of the protocol stack, such as the RLC, MAC, PHY, etc. A single CU may control multiple DUs, and each DU may be associated with one or more cells.

The second device 504 may be a base station in some examples. The second device 504 may be a TRP in some examples. The second device 504 may be a network component, such as a DU, in some examples. The second device 504 may be another UE in some examples, e.g., if the communication between the first wireless device 502 and the second device 504 is based on sidelink. Although some example aspects of machine learning and a neural network are described for an example of a UE, the aspects may similarly be applied by a base station, an IAB node, or another training host.

Among others, examples of machine learning models or neural networks that may be included in the first wireless device 502 include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with an input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights (e.g., each weight may correspond to one gradient in the gradient vector). The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

Reinforcement learning is a type of machine learning that involves the concept of taking actions in an environment in order to maximize a reward. Reinforcement learning is a machine learning paradigm; other paradigms include supervised learning and unsupervised learning. Basic reinforcement learning may be modeled as a Markov decision process (MDP) having a set of environment and agent states, and a set of actions of the agent. The process may include a probability of a state transition based on an action and a representation of a reward after the transition. The agent's action selection may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples. Federated learning (FL) procedures that use edge devices (e.g., devices not in the core network) as clients may rely on the clients being trained based on supervised learning.

Regression analysis may include statistical processes for estimating the relationships between a dependent variable (e.g., which may be referred to as an outcome variable) and independent variable(s). Linear regression is one example of regression analysis. Non-linear models may also be used. Regression analysis may include inferring causal relationships between variables in a dataset.

Boosting includes one or more algorithms for reducing bias and/or variance in supervised learning, such as machine learning algorithms that convert weak learners (e.g., a classifier that is slightly correlated with a true classification) to strong ones (e.g., a classifier that is more closely correlated with the true classification). Boosting may include iterative learning based on weak classifiers with respect to a distribution that is added to a strong classifier. The weak learners may be weighted related to accuracy. The data weights may be readjusted through the process. In some aspects described herein, an encoding device (e.g., a UE, base station, or other network component) may train one or more neural networks to learn dependence of measured qualities on individual parameters.

The machine learning models may include computational complexity and substantial processor for training the machine learning model. FIG. 5 illustrates that an example neural network 506 may include a network of interconnected nodes. An output of one node is connected as the input to another node. Connections between nodes may be referred to as edges, and weights may be applied to the connections/edges to adjust the output from one node that is applied as the input to another node. Nodes may apply thresholds in order to determine whether, or when, to provide output to a connected node. The output of each node may be calculated as a non-linear function of a sum of the inputs to the node. The neural network 506 may include any number of nodes and any type of connections between nodes. The neural network 506 may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse a layer multiple times. As an example, the first wireless device 502 may input information 510 to the neural network 506 (e.g., via a task/condition manager 518), and may receive output 512 (e.g., via a controller/processor 520). The first wireless device 502 may report information 514 to the second device 504 based on the output 512. In some aspects, the second device may transmit communication to the first wireless device 502 based on the information 514. In some aspects, the second device 504 may be a base station that schedules or configures a UE (e.g., the first wireless device 502) based on the information 514, e.g., at 516. In other aspects, the base station may collect information from multiple training hosts, e.g., from multiple UEs. Similarly, a network may collect information from multiple training hosts including multiple base stations, multiple IAB nodes, and/or multiple UEs, among other examples.

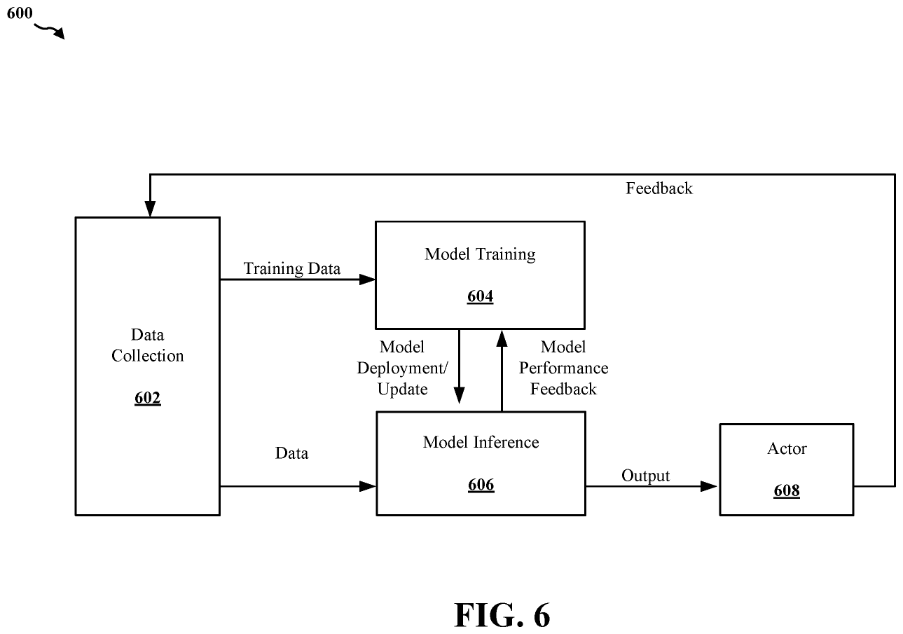

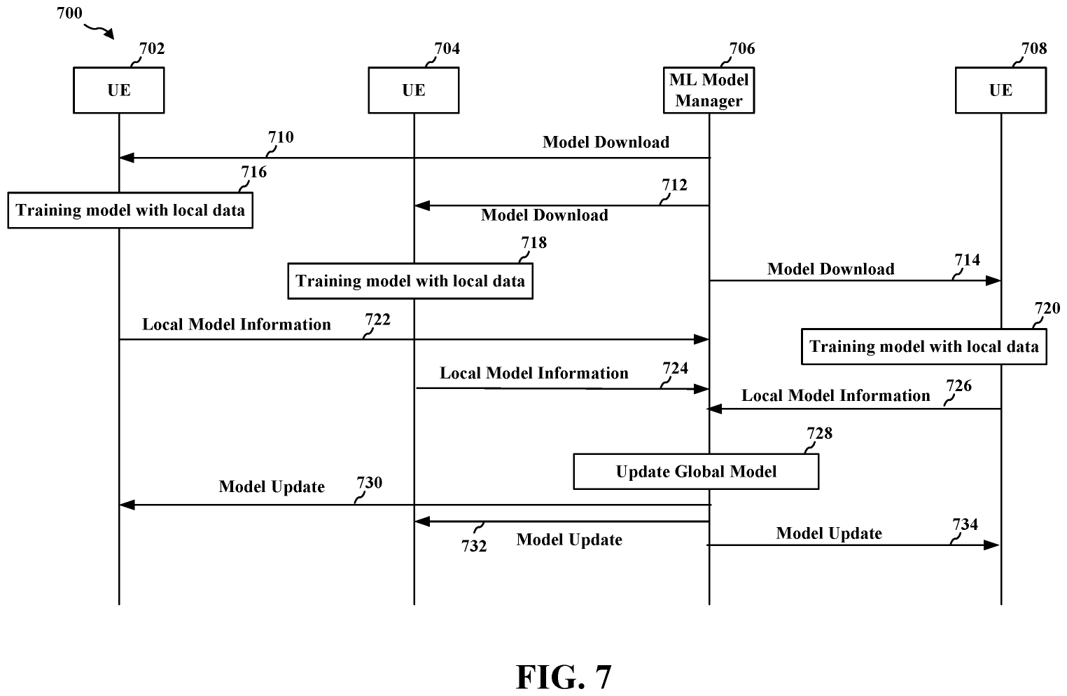

FIG. 6 is an example of the AI/ML model 600 for a method of wireless communication. The AI/ML model 600 may include various functions including a data collection 602, a model training function 604, a model inference function 606, and an actor 608. As described in connection with FIGS. 4 and 7, the actors 608 may include multiple UEs that share information with the network.

The data collection 602 may be a function that provides input data to the model training function 604 and the model inference function 606. The data collection 602 function may include any form of data preparation, and it may not be specific to the implementation of the AI/ML algorithm (e.g., data pre-processing and cleaning, formatting, and transformation). The examples of input data may include, but not limited to, gradient updates, from network entities including UEs or network nodes, feedback from the actor 608, output from another AI/ML model. The data collection 602 may include training data, which refers to the data to be sent as the input for the AI/ML model training function 604, and inference data, which refers to be sent as the input for the AI/ML model inference function 606.

The model training function 604 may be a function that performs the ML model training, validation, and testing, which may generate model performance metrics as part of the model testing procedure. The model training function 604 may also be responsible for data preparation (e.g., data pre-processing and cleaning, formatting, and transformation) based on the training data delivered or received from the data collection 602 function. The model training function 604 may deploy or update a trained, validated, and tested AI/ML model to the model inference function 606, and receive a model performance feedback from the model inference function 606.

The model inference function 606 may be a function that provides the AI/ML model inference output (e.g., predictions or decisions). The model inference function 606 may also perform data preparation (e.g., data pre-processing and cleaning, formatting, and transformation) based on the inference data delivered from the data collection 602 function. The output of the model inference function 606 may include the inference output of the AI/ML model produced by the model inference function 606. The details of the inference output may be use-case specific. As an example, the output may include gradient updates and/or model updates that are provided to the UEs communicating with the network.

The model performance feedback may refer to information derived from the model inference function 606 that may be suitable for improvement of the AI/ML model trained in the model training function 604. The feedback from the actor 608 or other network entities (via the data collection 602 function) may be implemented for the model inference function 606 to create the model performance feedback.

The actor 608 may be a function that receives the output from the model inference function 606 and triggers or performs corresponding actions. The actor may trigger actions directed to network entities including the other network entities or itself. The actor 608 may also provide feedback information that the model training function 604 or the model inference function 606 to derive training or inference data or performance feedback, e.g., as described herein. The feedback may be transmitted back to the data collection 602.

The network may use machine-learning algorithms, deep-learning algorithms, neural networks, reinforcement learning, regression, boosting, or advanced signal processing methods for aspects of wireless communication including the identification of neighbor TCI candidates for autonomous TCI candidate set updates based on DCI selection of a TCI state. In some aspects described herein, the network may train one or more neural networks to learn dependence of measured qualities on individual parameters.

In some examples, a first UE (i.e., one of multiple UEs participating in a federated learning round) may identify, in at least one round of a federated learning procedure, at least one gradient update based on local data and a local copy of a machine learning model associated with the federated learning procedure. The first UE may transmit, in the at least one round of the federated learning procedure, based on a non-coherent OTA aggregation scheme and for a network node (e.g., a parameter server), an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update.

In some examples, the network node (e.g., the parameter server) may receive, in the at least one round of the federated learning procedure, energy associated with a plurality of sequences and at least one combined gradient update via the set of resources for a plurality of UEs including the first UE. The plurality of sequences may include one sequence for each UE in the plurality of UEs. The network node may identify, in the at least one round of the federated learning procedure, the at least one combined gradient update based on the energy associated with the plurality of sequences averaged over the set of resources. The network node may update, in the at least one round of the federated learning procedure, a machine learning model associated with the federated learning procedure based on the at least one combined gradient update.

Accordingly, the non-coherent OTA aggregation scheme described herein may enable the UEs participating in a federated learning round to share the full gradients with the parameter server without performing channel pre-compensation. In some configurations, the non-coherent OTA aggregation scheme may be used with no CSI being specified at the UEs. In some other configurations, for the non-coherent OTA aggregation scheme, limited CSI (e.g., the long-term average channel gain) may be used at the UE. Further, UEs with limited Tx power may be capable of executing the non-coherent OTA aggregation scheme described herein.

FIG. 7 illustrates an example communication flow 700 between a network component and one or more UEs for federated learning. Federated learning may be applied in wireless communication, and may involve data transmissions between a server (e.g., a node in the network and/or base station) and distributed UEs. The UEs may include any of the examples described in connection with FIG. 1. The network node may include a federated learning manager, which may also be referred to as an ML model manager 706, or by another name. The federated learning illustrated in connection with FIG. 7 may include privacy protection by sharing model information without data sharing (e.g., local data at the UEs). As illustrated at 710, 712, and 714, the ML model manager 706 shares a global model among one or more scheduled UEs (e.g., UEs 702. 704, and/or 708). Although illustrated as three separate transmissions of the model, at 710, 712, and 714, one or more of the transmissions may be a combined transmission to multiple UEs. Each UE trains the received model based on its local data, e.g., at 716, 718, and 720. Each UE independently performs the model training based on their own local data. After the training, the one or more UEs may transmit information about an updated model based on the training performed at the UE. For example, the UEs may report, at 722, 724, and/or 726, an updated model information to the ML model manager 706. As described herein, the UE may provide gradient information to the ML model manager 706. The ML model manager may update the global model, at 728, based on the model update(s) received from one or more of the UEs 702, 704, 708. As an example, the ML model manager may converge the updated models (e.g., as received at 722, 724, 726). The ML model manager may apply an averaging algorithm in order to update the global model, at 728. After updating the global model, the ML model manager 706 transmits the updated global model to the UEs, at 730, 732, 734. Although the transmissions are illustrated as separate transmissions, in some aspects, the ML model manager may broadcast the updated global model in a combined transmission that is received by the UEs 702, 704, and 708. A single round or iteration is shown in FIG. 7. e.g., with the information provided by the UEs at 722, 724, and 726 followed by the model update. Multiple iterations or rounds may be performed.

Each of the scheduled UEs may report the updated model information to the server. The model may be relatively large in size, e.g., 1,000 to 1 million parameters or more. Multiple models may be used to adapt to different tasks and different conditions, which may be updated and reported to the base station. In addition to model size and/or the number of models, varying conditions within an environment may cause frequent federated learning training procedures. In downlink, federated learning training rounds may be associated with lower resource costs, as the network may broadcast the global federated learning model one time for a particular federated learning training round. However, because there may be many different distributed users in uplink, each UE may report the updates individually. Thus, the uplink resource cost via the Uu link may be large, especially for the UL/DL asymmetric slot formats where the UL resource is limited.

The base station may broadcast a global federated learning model to a plurality of UEs at the same time. After the UEs receive the global model, each UE may train the model based on a local data set. Uplink reporting of the trained model may be based on model size, a number of federated learning models to be reported, a frequency of federated learning training events, and/or available uplink resources in configured slots. After the federated learning model training is performed, each UE may report the model update to the base station. In some cases, uplink model report by each of the UEs may cause a bottleneck in the uplink Uu resources.

In federated learning, a group of UEs may cooperate to train a global ML model, e.g., an ML model used at the network for communication with multiple UEs, without sharing local datasets of the UEs. In particular, each UE may collect its own private dataset. Then, the UEs may cooperate to minimize a global loss function at the parameter server (which may be a network entity, such as a base station, etc.) (also referred to as an edge server). A loss function may refer to a function that measures the difference between the predicted output of an ML model and the actual output for a given input, and a global loss function refers to the loss function of the global ML model, e.g., used by the network with multiple UEs. At each iteration/round (referred to interchangeably as a federated learning round, a communication round, or a feedback round), the parameter server may broadcast a global training parameter vector (i.e., the weights of the parameters for the global ML model as maintained at the parameter server) to the UEs. Each UE may estimate one or more gradients that may minimize the loss function on a batch of data in the local dataset of the UE. Each UE may then process the local gradients, and may share a processed version of the local gradients with the parameter server.

In some aspects, analog federated learning may be utilized, where each UE may transmit the information about the gradients using analog signals. In particular, for the analog federated learning, the gradients at each UE may be rescaled to satisfy the power constraint and to mitigate the effect of channel noise. In other words, to transmit information about a gradient, a UE may transmit a signal on a specified resource with channel pre-compensation, where the Tx power of the signal (within the specified power constraint) may be based on the value of the gradient. Further, the aggregation may be performed OTA. In some aspects, digital federated learning may be utilized. In particular, for the digital federated learning, the gradients from each UE may be compressed, and may be transmitted to the parameter server using a multi-access scheme (e.g., a scheme that allows multiple users to share the same communication channel). Further, the parameter server may then aggregate the gradients.

In some aspects, the parameter server may combine the local gradients to obtain the global (combined) gradient set. Then, the parameter server may update the global training parameter vector using the estimated global gradient set, e.g., multiple gradients, each corresponding to a parameter, as the ML model includes multiple parameters.

The federated learning technique may be associated with a number of benefits. The privacy of the local data at the UE may be protected because for federated learning, the local gradients may be shared with the parameter server without sharing the actual local data of each UE. Further, centralized ML model training (e.g., training performed centrally at the parameter server without the assistance of the UEs) may be inefficient in terms of storage and/or computation, whereas the federated learning technique may provide natural parallelization for the model training process.

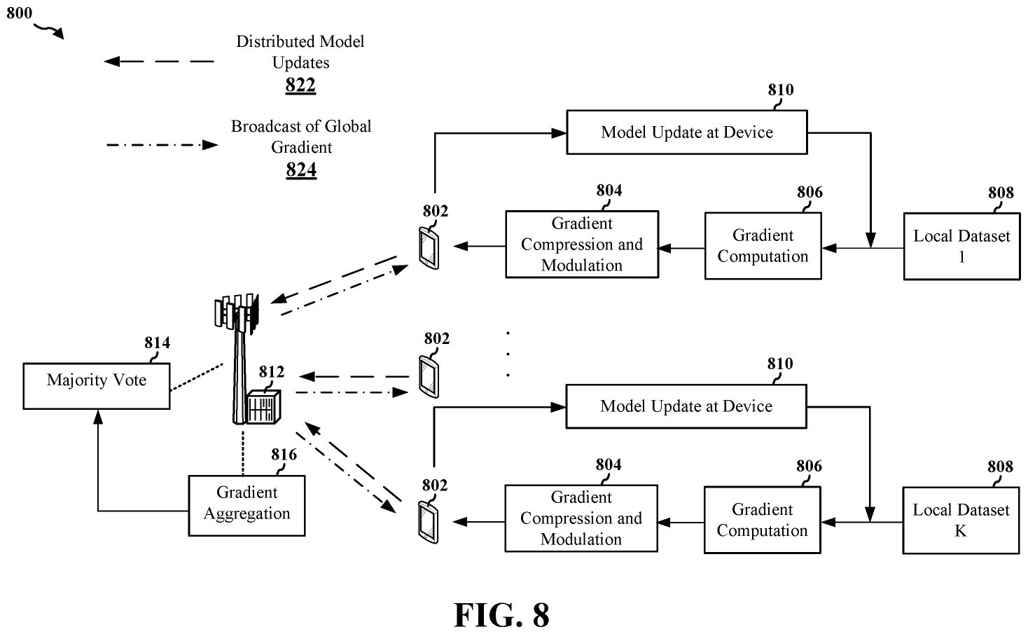

FIG. 8 is a diagram of an example environment 800 associated with federated learning. The parameter server 812 (which may also be referred to as an edge server in some examples) may correspond to a network component or a component of a base station 102/180/410. The device 802 may correspond to the UE 104/450. Federated learning may be a technique that may enable users (e.g., UEs or other devices, which may be referred to as edge devices (e.g., a device that is not a part of a core network)) to train an ML model (e.g., a neural network) in a collaborative and distributed fashion using users' local datasets at distributed devices (e.g., UEs). For example, in each iteration/round, a parameter server 812, such as at a base station or a component of a network) may select a number of devices 802, and may transmit 824 a copy of the global ML model (e.g., the copy may include the parameters (weights) or a gradient set of the global ML model) to each of the selected devices 802. Then, at 806, each device 802 may compute updated local model parameters (weights) and/or gradients (or gradient set elements) of the ML model based on a local copy of the ML model (which may be referred to as the local ML model hereinafter) that is updated, at 810, based on the local dataset 808 at the device 802. At 804, each device 802 may compress and/or modulate the computed local gradients (or gradient set elements) in preparation for transmission. Next, each device 802 may feedback, at 822, the corresponding update including the updated local model parameters (weights) or the local gradient set elements to the parameter server 812. Thereafter, the parameter server 812 may aggregate, at 816, the updates 822 from the devices 802, and may update, at 814, the global ML model based on the aggregated updates and a majority vote (e.g., determining the sign of the global gradient based on the sign of the majority of the local gradients). A round or iteration may refer to the process in which the device 802 provides the gradient information and receives a model update. Multiple rounds or iterations may be performed, e.g., with the UE calculating a gradient based on the model update, sending additional gradient information for the model update, and receiving a further model update. For the next iteration/round, the parameter server 812 may transmit a copy of the updated global machine model (e.g., parameters (weights) or a global gradient set) to selected devices 802, and the devices 802 may perform again similar operations as described above. The process may be repeated for a number of times corresponding to a number of iterations/rounds until the global ML model converges (e.g., until the global ML model update may no longer produce any changes to the global ML model, or until the changes are less than one or more thresholds).

Federated learning may keep the user data 808 private at the devices 802 based on the distributed optimization framework. In other words, the user data itself may not be transmitted from the devices 802 to the parameter server 812.

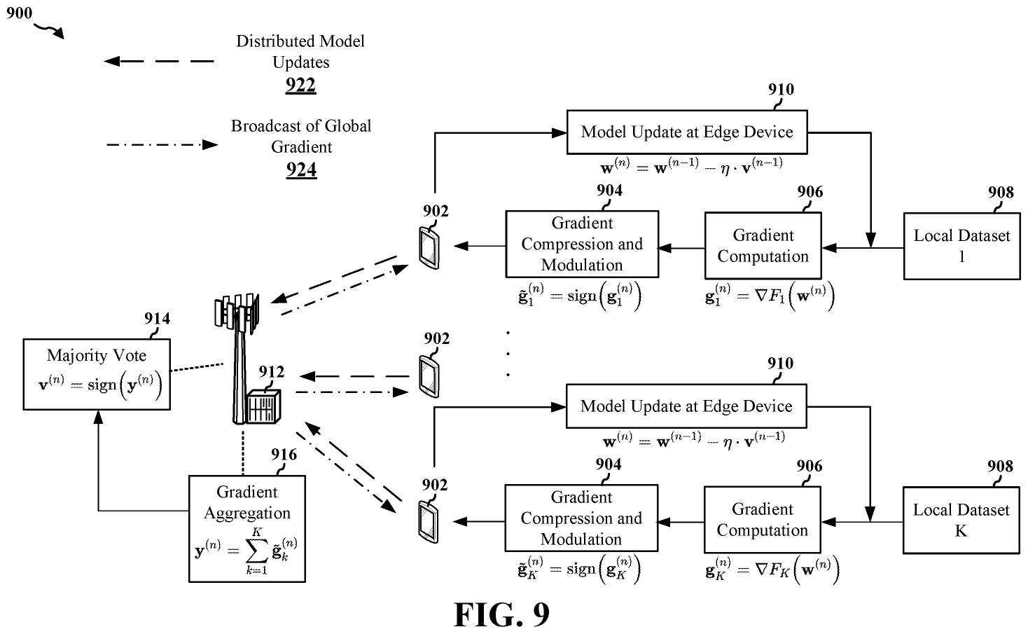

FIG. 9 is a diagram of an example environment 900 associated with federated learning. The parameter server 912 (which may also be referred to as an (edge) server in some examples) may be a component of a core network or may be a component of the base station 102/180/410, in some aspects. The edge device 902 may correspond to the UE 104/450. Federated learning may be a technique that may enable users (e.g., UEs or edge devices) to train an ML model (e.g., a neural network) in a collaborative and distributed fashion using users' local datasets at distributed devices (e.g., UEs). For example, in each iteration/round, a parameter server 912 may select a number of devices 902, and may transmit 924 a copy of the global ML model (e.g., the copy may include the parameters (weights) or a gradient set of the global ML model) to each of the selected devices 902. Then, at 906, each device 902 may compute updated local model parameters (weights) and/or gradients (or gradient set elements) of the ML model based on a local copy of the ML model (which may be referred to as the local ML model hereinafter) that is updated, at 910, based on the local dataset 908 at the device 902. At 904, each device 902 may compress and/or modulate the computed local gradients (or gradient set elements) in preparation for transmission. Next, each device 902 may feedback, at 922, the corresponding update including the updated local model parameters (weights) or the local gradient set elements to the parameter server 912. Thereafter, the parameter server 912 may aggregate, at 916, the updates 922 from the devices 902, and may update, at 914, the global ML model based on the aggregated updates and a majority vote (e.g., determining the sign of the global gradient based on the sign of the majority of the local gradients). For the next iteration/round, the parameter server 912 may transmit a copy of the updated global machine model (e.g., parameters (weights) or a global gradient set) to selected devices 902, and the devices 902 may perform again similar operations as described above. The process may be repeated for a number of times corresponding to a number of iterations/rounds until the global ML model converges (e.g., until the global ML model update may no longer produce any changes to the global ML model, or until the changes are less than one or more thresholds).

Federated learning may keep the user data (e.g., 908) private at edge devices 902 based on the distributed optimization framework. In other words, the user data itself may not be transmitted from the edge devices 902 to the parameter server 912.

One of the challenges of analog OTA federated learning may be that the analog OTA federated learning may be based on channel pre-compensation at the UE (e.g., for coherent combining). The channel pre-compensation at the UE may impose additional challenges. As a first example, the channel pre-compensation at the UE may be based on the availability of the CSI at the UE (because the channel pre-compensation involves applying an inverse distortion at the transmitter based on the information about the channel distortion). However, the CSI may not be available at the UE (e.g., in a 3GPP system). As an additional example, the channel pre-compensation at the UE may involve the use of additional Tx power at the UE; however, the UE may have limited Tx power (e.g., due to hardware and energy storage limitations).

To address the above-described challenges associated with analog OTA gradient accumulation for federated learning, one or more aspects of the disclosure may provide a non-coherent combining scheme based on which the UEs participating in the federated learning procedure may send the full gradient(s) (e.g., instead of using a coherent combining scheme that involves the use of the CSI or sending the signs of the gradients rather than the full gradient). In some configurations, based on the aspects described herein, the UE may send the gradient information even if CSI is not available at the UE. In some other configurations, limited CSI (e.g., the long-term average channel gain) may be used at the UE.

To assist in the description of the disclosure, some parameters associated with the federated learning procedure are provided. In a communication round (i.e., federated learning round) n, the k-th UE may calculate at least one gradient gₖ⁽ⁿ⁾ based on a batch of local dataset at the k-th UE, and may send the at least one gradient gₖ⁽ⁿ⁾ to the network (e.g., a base station, a parameter/edge server). For OTA federated learning, multiple UEs may share the same resource(s) on which the UEs may transmit the gradient. In particular, each UE may transmit

$$\frac{{g}_{k}^{( n )}}{{h}_{k}^{( n )}} ,$$

where hₖ⁽ⁿ⁾ may be the channel coefficient of the resource (i.e., channel pre-compensation). Different channel pre-compensation schemes may be used at the UE. Example channel pre-compensation schemes may include zero forcing or minimum mean square error (MMSE), etc.

Upon receiving the transmissions from the UEs, the network may combine the gradients from the multiple UEs by summing the gradients from the UEs as follows:

$${g}^{( n )} = \frac{1}{K} {\sum }_{k = 1}^{K} {h}_{k}^{( n )} \frac{{g}_{k}^{( n )}}{{h}_{k}^{( n )}} = \frac{1}{K} {\sum }_{k = 1}^{K} {g}_{k}^{( n )}$$

For OTA federated learning, the gradient combining may be performed OTA utilizing the superposition property of the wireless channel. Because the UEs perform the channel pre-compensation, the gradients may be coherently combined.

Based on the combined gradients, the network (e.g., the base station, the parameter/edge server) may update the global training parameters (weights) before sending the updated global training parameters (weights) to the UEs. The updating of the global training parameters may be represented as follows:

$${w}_{k}^{( n + 1 )} = {w}_{k}^{( n )} - η {g}^{( n )} ,$$

where η may be the learning rate.

The network may use the sum of the gradients

$${g}^{( n )} = \frac{1}{K} {\sum }_{k = 1}^{K} {g}_{k}^{( n )}$$

to update the global ML model, but may not need the individual gradient values gₖ⁽ⁿ⁾.

In some configurations, resources and waveforms may be specified for the non-coherent OTA aggregation. For example, for each federated learning parameter, the network may assign a set of L resources shared among the UEs participating in the federated learning procedure. Over these L resources of the set, each UE may transmit a sequence sₖ⁽ⁿ⁾ (e.g., a (pseudo-)random sequence) of length L. Furthermore, s_{k,l}⁽ⁿ⁾ may denote the l-th element of the sequence transmitted by the k-th UE at the n-th communication round, where k may be the UE index, where k=0, . . . , K-1, l may be the feedback resource index, where l=0, . . . , L-1, and n may be the iteration (round) of federated learning feedback. Moreover, sₖ⁽ⁿ⁾∈ [symbol] may be a (pseudo-)random sequence, which may be independent (different) across UEs.

In some configurations, s_{k,l}⁽ⁿ⁾ may be selected (designed) such that the transmit power for s_{k,l}⁽ⁿ⁾ may be proportional to the gradient of the corresponding parameter, while the pathloss may be accounted for as follows:

$$E \{ {\vert {s}_{k , l}^{( n )} \vert}^{2} \} = {P}_{k}^{( n )} [ dBm ] + {Γ}_{k} [ dB ]$$

$$( or \{ {\vert {s}_{k , l}^{( n )} \vert}^{2} \} = min \{ {P}_{ma x} , {P}_{k}^{( n )} [ dBm ] + {Γ}_{k} [ dB ] \} , if UE Tx power is limited ) ,$$

where Γₖ may be the pathloss, and Pₖ⁽ⁿ⁾ may be proportional to the gradient of the corresponding training parameter in linear scale. In some configurations, Tx power control may be supported in the communication standards (e.g., LTE, NR, or a future generation wireless communication standard), and no separate pathloss compensation may be performed for the OTA aggregation. In some configurations, the gradient (gₖ⁽ⁿ⁾) may take negative values, while the power of the sequence may take just positive values. Accordingly, in some configurations, Pₖ⁽ⁿ⁾ may be proportional to the gradient plus an offset (value) (g_{offset}), to convert the gradient range to a non-negative (just positive) range. For example, Pₖ⁽ⁿ⁾=max{gₖ⁽ⁿ⁾+g_{offset},0}. In different configurations, s_{k,l}⁽ⁿ⁾ may be constant modulus (i.e., just the phase is random) or non-constant modulus.

In some configurations, the network may assign multiple resources (e.g., a set of L resources) for the transmission of the gradient of the same federated learning parameter. Accordingly, the UEs participating in a federated learning round may transmit the gradient of the corresponding federated learning parameter non-coherently on the same set of resources to ensure OTA aggregation of the signal power.

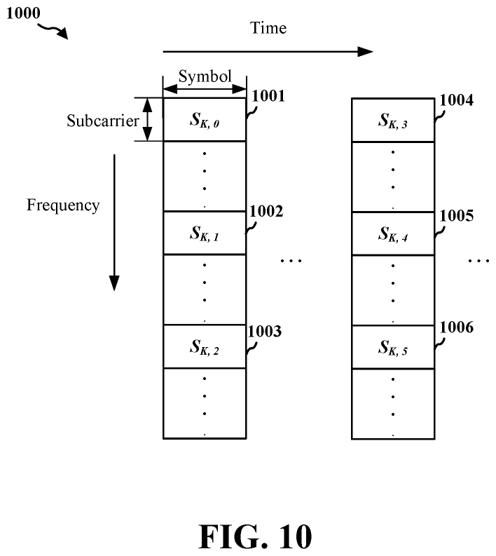

FIG. 10 is a diagram 1000 illustrating an example resource configuration in a time domain (e.g., symbols) and frequency domain (e.g., subcarriers) that may be used for UEs to provide information for non-coherent OTA aggregation. FIG. 10 illustrates a set of resources 1001, 1002, 1003, 1004, 1005, and 1006 in time and frequency that may be assigned to be shared among UEs participating in the federated learning. As described above, each UE may transmit a sequence sₖ over L resources of the set (e.g., a (pseudo-)random sequence) of length L. Furthermore, s_{k,l} may denote the l-th element of the sequence transmitted by the k-th UE, where k may be the UE index, where k=0, . . . , K-1, l may be the feedback resource index, where l=0, . . . , L-1. As shown, the feedback resources (i.e., the resources for the transmission by the UEs of gradients for OTA aggregation) may be distributed across frequency (subcarriers) and/or time (symbols).

At each federated learning round, e.g., as shown in FIGS. 7, 8, and 9, the network (e.g., the base station, the parameter/edge server) may receive the energy corresponding to the aggregated transmissions from the UEs participating in the round. In some configurations, the network may compute an average Rx power across the feedback resources. The Rx power for the l-th resource may be represented as follows:

$${y}_{l} = {\sum }_{k} {h}_{k , l} {s}_{k , l} + {n}_{l} ,$$

where h_{k,l} may be the channel coefficient. Accordingly, with proper Tx power control, E{|h_{k,l}|²}=−Γₖ [dB].

The network may average the received power over the set of L resources to equalize the channel as follows:

$$E \{ {\vert {y}_{l} \vert}^{2} \} = {\sum }_{k} E \{ {\vert {h}_{k , l} \vert}^{2} \} \cdot E \{ {\vert {s}_{k , l} \vert}^{2} \} + E \{ {\vert {n}_{l} \vert}^{2} \} = {\sum }_{k} {P}_{k} + {σ}_{n}^{2}$$

Accordingly, the average Rx power over the set of L resources (e.g., 1001, 1002, 1003, 1004, 1005, and 1006) may be proportional to the sum of the gradients as shown for the calculation of E{|yₗ|²}.

Because the above approach may be based on the average received power on multiple REs, a sequence transmission may be used to ensure that the small scale fading channels may be averaged out, thus allowing the Rx power to be proportional to the sum of the gradients. The network may be interested just in the sum of the gradients, and the superposition property of the wireless channel may be utilized to sum the energies from the different UEs.

Next, in some configurations, the network may update the global training parameters for the next communication round as follows:

$${w}^{( n + 1 )} = {w}^{( n )} - η ( \frac{E \{ {\vert {y}_{l} \vert}^{2} \}}{K} ) \approx {w}^{( n )} - η {g}^{( n )} ,$$

where K may be the number of UEs, and η may be the learning rate. Thereafter, the network may share the updated training parameters (weights) (which may be represented in gradients) for the global ML model with the UEs.

In some configurations, the network may configure the UEs, such that based on the configuration, the UEs may send the federated learning updates (e.g., gradients) including scaling the power of the symbols in the ((pseudo-)random) sequence to be proportional at least in part to the gradient values. Therefore, in some configurations, instead of transmitting the actual gradient values using a coherent scheme based on OTA federated learning aggregation, which may involve channel pre-compensation at the UE, a UE participating in the federated learning round may, based on the configuration from the network, scale the power of the (pseudo-random) sequence to be proportional at least to the sum of the gradient value and the pathloss, so as to avoid performing channel pre-compensation at the UE side. For example, rather than transmitting the actual gradient values using a coherent transmission scheme (with channel pre-compensation), the UE may transmit a sequence (e.g., a random sequence or pseudo-random sequence) using a scaled power that is proportional to the gradient value and a pathloss. The use of the scaled transmission power enables the network to receive transmissions of gradient information from multiple UEs for a corresponding federated learning parameter non-coherently on a same set of resources.

One example way of applying the above approach may be represented as follows:

$$E \{ {\vert {s}_{k , l}^{( n )} \vert}^{2} \} = {P}_{k}^{( n )} + {Γ}_{k}$$

$$or$$

$$E \{ {\vert {s}_{k , l}^{( n )} \vert}^{2} \} = min \{ {P}_{ma x} , {P}_{k}^{( n )} + {Γ}_{k} \} ,$$

where Pₖ⁽ⁿ⁾∝gₖ⁽ⁿ⁾. In some configurations, the pathloss (Γₖ) compensation may already be a part of UL power control (e.g., in LTE, NR, or a future wireless communication system) and there may be no need to make changes for the pathloss compensation.

In some configurations, the network may configure the power quantization levels for the federated learning updates (gradients) for the UEs. In particular, the UEs may be configured to scale the powers of a ((pseudo-)random) sequence to be proportional to the gradient updates according to the specific/specified quantization levels. In some configurations, the quantization level configuration may be on a UE group basis. In other words, the network may configure quantization levels for each group of UEs. Accordingly, a UE may apply the quantization levels configured for the UE group to which the UE belongs. Configuring quantization levels on the UE group basis may help to simplify UE implementation. After aggregating the gradient updates from multiple UEs, the quantization error may be averaged out across UEs, and the impact of the quantization error on the final combined gradient (i.e., sum of gradients) may be negligible.

In some configurations, the network may configure the UEs, such that the UEs may, based on the configuration from the network, send the federated learning updates including scaling the power of the symbols in the ((pseudo-)random) sequence to be proportional at least in part to the gradient values plus a (common) offset (value). Gradient values may be negative, while the power of the pseudo-random sequence may take just positive values. Accordingly, the network may configure a bias (value) (i.e., the common offset value), which may be added to the gradient value to convert the gradient range to a non-negative (just positive) range. As a result, the transmitted power values may represent both positive and negative gradient values.

One example way of applying the above approach may be represented as follows:

$$E \{ {\vert {s}_{k , l}^{( n )} \vert}^{2} \} = {P}_{k}^{( n )} + {Γ}_{k} ,$$

$$where$$

$${P}_{k}^{( n )} = max \{ α \cdot {g}_{k}^{( n )} + {g}_{offset} , 0 \} .$$

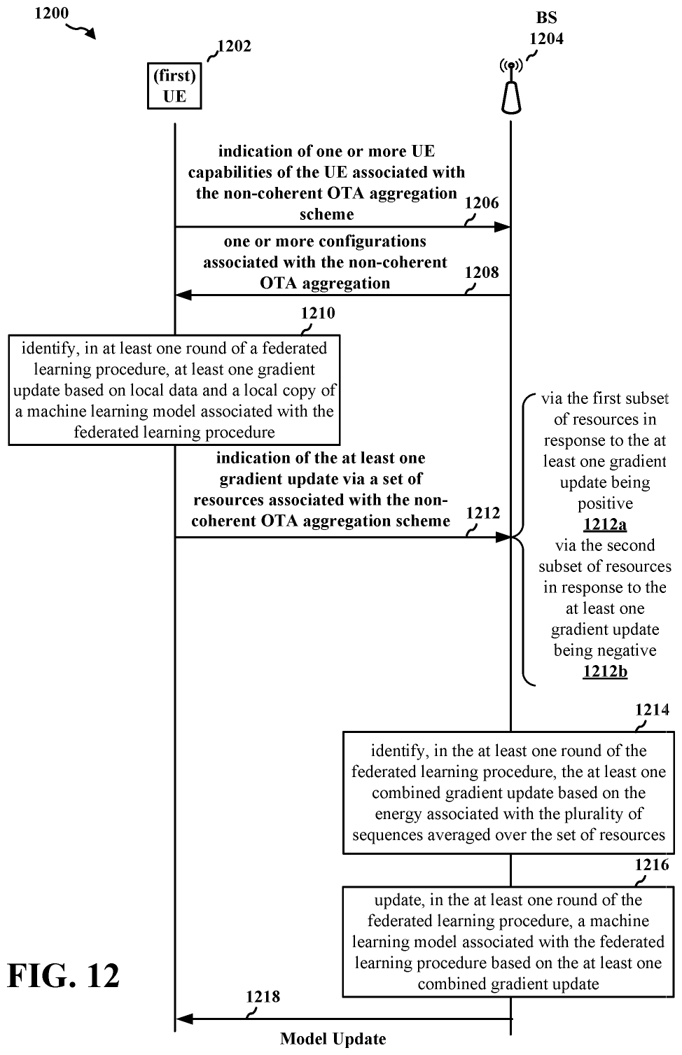

The network may select the bias value that may provide an offset to the sequence power based on one or more factors. FIG. 12 illustrates an example communication flow between a UE and a network. In some aspects, the network may indicate the offset to the UE in the configuration associated with non-coherent OTA aggregation, e.g., at 1208. For example, the factors may include the expected pathloss statistics at different UEs (e.g., mean, mode, range, distribution, etc.), the maximum power available at each UE, and so on. The information useful for the selection of the bias value may be available just at the network side. Therefore, the network, instead of the UEs, may select the bias value. Furthermore, the bias may have the same value at each of the UEs. Accordingly, the network may act as a central node in the configuration of the bias value to ensure that the UEs use the same bias value.

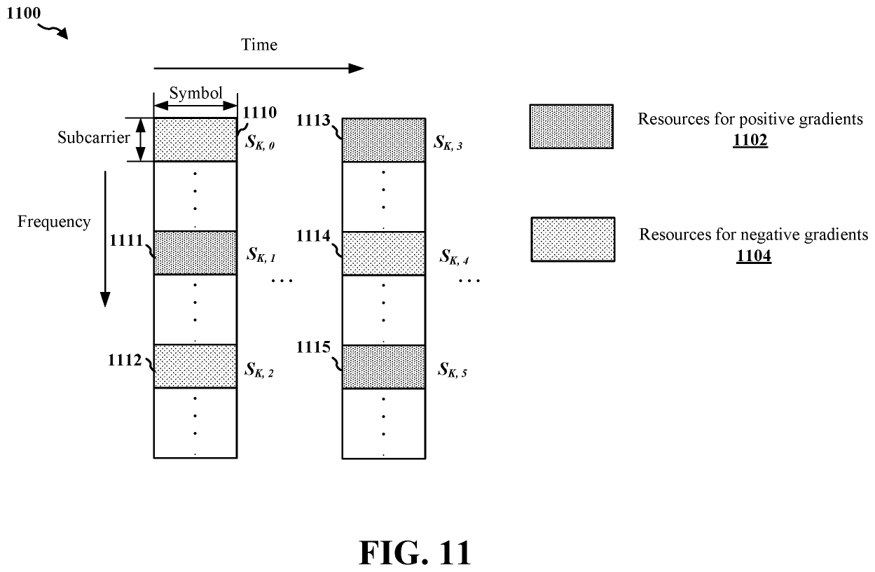

In some configurations, the network may configure the UEs with two sets of resources (or two subsets in a single set of resources), such that the first set (subset) of resources may be used for the transmission of positive gradients and the second set (subset) of resources may be used for the transmission of negative gradients. As described in more detail below, FIG. 11 illustrates an example resource diagram 1100 showing different sets of resources, e.g., 1102 and 1104, that may be configured for the transmission of positive and negative gradients. Accordingly, a UE participating in a federated learning round may estimate a gradient based on a batch of the local dataset at the UE. If the gradient is positive, the UE may transmit the ((pseudo-)random) sequence on the first set (subset) of resources and may not transmit on the second set of resources. On the other hand, if the gradient is negative, the UE may transmit the ((pseudo-)random) sequence on the second set of resources (e.g., using a power that is proportional to the absolute value of the gradient) and may not transmit on the first set of resources. Accordingly, in some configurations, instead of using a (power) offset to enable the representation of negative gradients, as described above, the representation of negative gradients may be enabled based on the use of separate sets (subsets) of resources.

FIG. 11 is a diagram 1100 illustrating an example resource configuration for non-coherent OTA aggregation. As shown, in one example configuration, the network may configure a set of resources for gradient transmissions, where even-indexed resources 1102 (e.g., 1110, 1112, 1114) may be used for transmissions of positive gradients and odd-indexed resources 1104 (e.g., 1111, 1113, 1115) may be used for transmissions of negative gradients. Accordingly, the network may combine the gradients received on both sets (subsets) of resources (e.g., subtracting the sum of gradients as represented by the average power over the resources 1104 for negative gradients from the sum of gradients as represented by the average power over the resources 1102 for positive gradients) to estimate the actual combined gradient.

In some configurations, the network may configure, e.g., at 1208, the UEs, such that the UEs may, based on the configuration from the network, send the federated learning updates including scaling the power of the symbols in the ((pseudo-)random) sequence to be proportional at least in part to the gradient values as well as the local batch sizes at the UEs participating in the federated learning procedure. In some configurations, different UEs may have different local data batch sizes (i.e., the dataset size used in each model update).

The network may update the global training parameters as follows:

$${w}^{( n + 1 )} = {w}^{( n )} - η \frac{1}{{\sum }_{k = 1}^{K} {D}_{k}} {\sum }_{k = 1}^{K} {D}_{k} {g}_{k}^{( n )} ,$$

where Dₖ may be the batch size at the k-th UE. In this case, the network may configure the UEs to scale the power of the (pseudo-random) sequence based on the local data batch size as well. For example, Pₖ⁽ⁿ⁾∝(Dₖgₖ⁽ⁿ⁾+g_{offset}), where g_{offset} may be the added power bias.

In some configurations, the network may configure, e.g., at 1208, the UEs, such that the UEs may, based on the configuration from the network, send the federated learning updates including scaling the power of the symbols in the ((pseudo-)random) sequence to be proportional at least in part to the gradient values as well as the local learning weights at the UEs. In some configuration, the local learning weights may be based on local learning rates. In some configurations, different UEs may have different learning rates (ηₖ).

The network may update the global training parameters (weights), e.g., at 1216, as follows:

$${w}^{( n + 1 )} = {w}^{( n )} - {\sum }_{k = 1}^{K} {η}_{k} {g}_{k}^{( n )}$$

Therefore, the network may configure, e.g., at 1208, the UEs to scale the power of the symbols in the (pseudo-random) sequence to be proportional at least in part to the gradient values as well as the local learning rates θₖ. For example, Pₖ⁽ⁿ⁾∝(ηₖgₖ⁽ⁿ⁾+g_{offset}). The network may indicate the update to the UE(s), at 1218.

In some additional configurations, the network may assign respective local learning weights to the UEs participating in the federated learning procedure. In one example, the network may calculate the local learning weights based on the local training loss at each UE. Further, the network may favor updates with lower loss, and may assign higher weights to UEs with lower loss. In another example, the network may calculate the local learning weights based on one or more of the locations of the UEs, the interference levels at the UEs, or the quality of the collected data at the UEs, etc.

The network may update the global training parameters (weights), e.g., at 1216, as follows:

$${w}^{( n + 1 )} = {w}^{( n )} - {\sum }_{k = 1}^{K} {v}_{k} {g}_{k}^{( n )} ,$$

where vₖ may be the weight assigned by the network to the k-th UE. For example, Pₖ⁽ⁿ⁾∝(vₖgₖ⁽ⁿ⁾+g_{offset}). The network may indicate the update to the UE(s), at 1218.

In some configurations, the network may configure/define, e.g., at 1208, multiple resources for the transmission of gradients for the federated learning parameters. For example, one or more sets of L resources may be configured for each federated learning parameter. In the non-coherent OTA aggregation approach described herein, the sum of gradients as received at the network (e.g., the base station, the parameter/edge server, etc.) may be perturbed by small-scale channel fading. For example, the Rx power at the I-th resource may be represented as follows:

$${y}_{l} = {\sum }_{k} {h}_{k , l} {s}_{k , l}$$

To compensate for the small scale channel fading at the network side and to obtain the sum of the gradients, the network may average the received power over the multiple resources. The averaging of the received power over the multiple resources may be represented as follows:

$$E \{ {\vert {y}_{l} \vert}^{2} \} = {\sum }_{k} {P}_{k} + {σ}_{n}^{2}$$

Therefore, the network may assign multiple resources (e.g., one or more sets of L resources) for each federated parameter to allow for the averaging of the Rx power over the multiple resources and the compensation for the small scale fading effects. Accordingly, the network may configure, e.g., at 1208, multiple uplink feedback resources for each federated learning parameter, where the multiple resources may be distributed across frequency (subcarriers) and/or time (symbols). Therefore, unlike the coherent OTA aggregation scheme where the channel may be pre-compensated at the UEs, in the non-coherent OTA aggregation scheme according to various aspects described herein, the channel may be averaged out.

Accordingly, in one or more configurations, the network (e.g., the base station, the parameter/edge server) may transmit a configuration, e.g., at 1208, for federated learning based on the non-coherent OTA aggregation scheme to the UEs participating in the federated learning procedure. The network may transmit the configuration via one of an RRC message, a MAC-CE, an SI message, or a DCI message. The configuration may include an indication of the power scaling scheme to be used (which may be one of the various example power scaling schemes described above) in the federated learning procedure. Based on the configuration, a UE participating in a federated learning round may transmit the federated learning updates (gradients) including scaling the power of the (pseudo-random) sequence based on the power scaling scheme as indicated in the configuration.

In some configurations, a UE may report, to the network, the capability of the UE associated with federated learning based on the non-coherent OTA aggregation scheme. In particular, the UE may report its capability associated with scaling the power of the transmitted sequence to match the gradient values. For example, the UE may indicate, in the report, one or more of the various example power scaling schemes described above that the UE may be capable of implementing. In some configurations, the network may configure the UEs for the federated learning based on the non-coherent OTA aggregation scheme and the UE capability reports received from the UEs.

FIG. 12 is a diagram of a communication flow of a method 1200 of wireless communication. The (first) UE 1202 may implement aspects of the UE 104/405/902. Further, the network node 1204 may implement aspects of the base station 102/410 or the parameter server 912. In one configuration, at 1206, the (first) UE 1202 may transmit, for the network node 1204, an indication of one or more UE capabilities of the (first) UE 1202 associated with the non-coherent OTA aggregation scheme.

In one configuration, at 1208, the network node 1204 may transmit, for the (first) UE 1202, one or more configurations associated with the non-coherent OTA aggregation scheme via at least one of an RRC message, a MAC-CE, an SI message, or a DCI message.

In one configuration, the one or more configurations at 1208 associated with the non-coherent OTA aggregation scheme may include a quantization level configuration associated with the transmit power for the at least one sequence.

At 1210, the (first) UE 1202 may identify, in at least one round of a federated learning procedure, at least one gradient update based on local data and a local copy of a machine learning model associated with the federated learning procedure.

At 1212, the (first) UE 1202 may transmit, in the at least one round of the federated learning procedure, based on a non-coherent OTA aggregation scheme and for the network node 1204, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update. The transmission of the indication of the gradient may correspond to the information that is provided at 722, 724, and 726 in the federated learning example in FIG. 7.

In one configuration, the transmit power for the at least one sequence may be proportional to the magnitude of the at least one gradient update.

In one configuration, the transmit power for the at least one sequence may be based at least in part on a sum of the magnitude of the at least one gradient update and an offset value.

In some configurations, the set of resources associated with the non-coherent OTA aggregation scheme may include a first subset of resources and a second subset of resources. Further, 1212 may include 1212a or 1212b. At 1212a, the (first) UE 1202 may transmit the at least one sequence via the first subset of resources in response to the at least one gradient update being positive.

At 1212b, the (first) UE 1202 may transmit the at least one sequence via the second subset of resources in response to the at least one gradient update being negative.

In one configuration, the transmit power associated with the at least one sequence may be further based on a local batch size associated with the (first) UE 1202.

In one configuration, the transmit power associated with the at least one sequence may be further based on a local learning weight associated with the (first) UE 1202.

In one configuration, the local learning weight associated with the (first) UE 1202 may be based on an assignment from the network node 1204.

In one configuration, the set of resources may span a configured range in time and/or frequency.

In one configuration, the at least one sequence may be a pseudorandom sequence.

In one configuration, the transmit power associated with the at least one sequence may be further based on a pathloss associated with a channel for the (first) UE 1202.

Further, at 1212, the network node 1204 may receive, in the at least one round of a federated learning procedure, energy associated with a plurality of sequences and at least one combined gradient update via the set of resources for (from) a plurality of UEs including a (first) UE 1202. The plurality of sequences may include one sequence for each UE in the plurality of UEs.

At 1214, the network node 1204 may identify, in the at least one round of the federated learning procedure, the at least one combined gradient update based on the energy associated with the plurality of sequences averaged over the set of resources.

At 1216, the network node 1204 may update, in the at least one round of the federated learning procedure, a machine learning model associated with the federated learning procedure based on the at least one combined gradient update. The update may correspond to the update performed at 728 in the example in FIG. 7, in some aspects. The network node 1204 may provide model update information to the UEs involved in federated learning, e.g., at 1218, which may correspond to 730 in FIG. 7. As described in connection with FIGS. 7, 8, and 9, the UEs and the network node may perform multiple iterations of providing gradient information, updating the model, providing gradient information for the updated mode, and further updating the model.

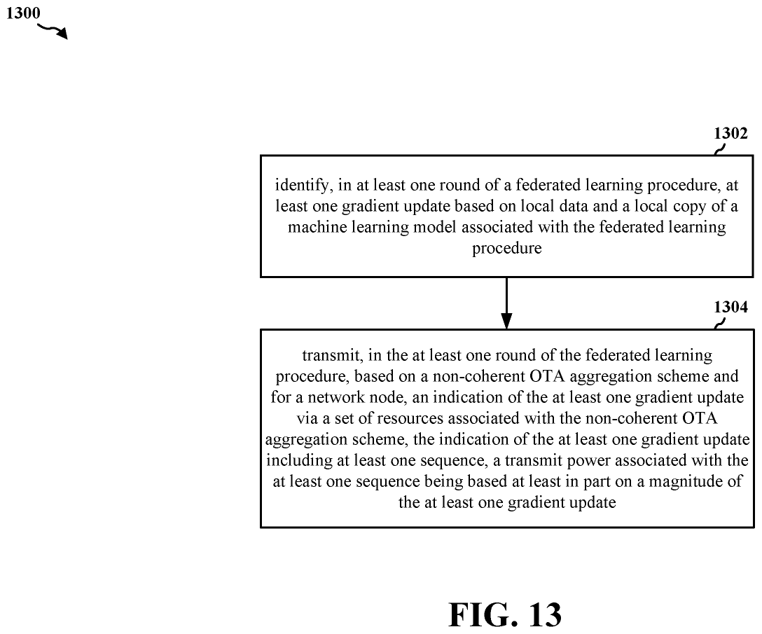

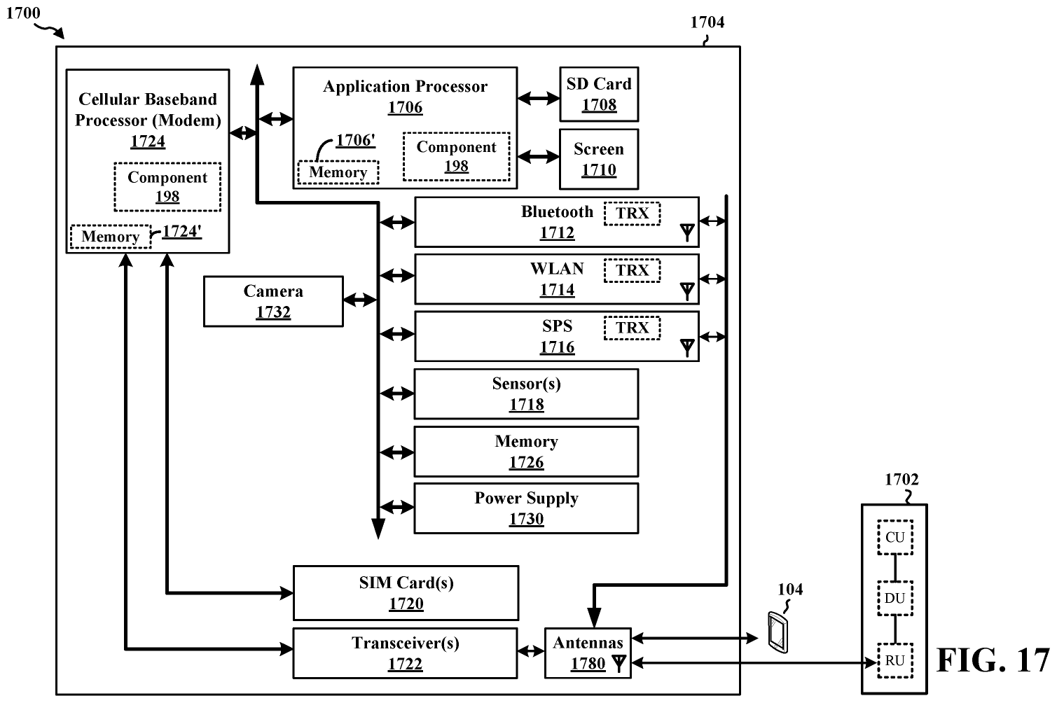

FIG. 13 is a flowchart 1300 of a method of wireless communication. The method may be performed by a UE (e.g., the UE 104/450/902/1202; the apparatus 1704). At 1302, the UE may identify, in at least one round of a federated learning procedure, at least one gradient update based on local data and a local copy of a machine learning model associated with the federated learning procedure. For example, 1302 may be performed by the component 198 in FIG. 17. Referring to FIG. 12, at 1210, the UE 1202 may identify, in at least one round of a federated learning procedure, at least one gradient update based on local data and a local copy of a machine learning model associated with the federated learning procedure.

At 1304, the UE may transmit, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update. For example, 1304 may be performed by the component 198 in FIG. 17. Referring to FIG. 12, at 1212, the UE 1202 may transmit, in the at least one round of the federated learning procedure, based on a non-coherent OTA aggregation scheme and for a network node 1204, an indication of the at least one gradient update via a set of resources associated with the non-coherent OTA aggregation scheme.

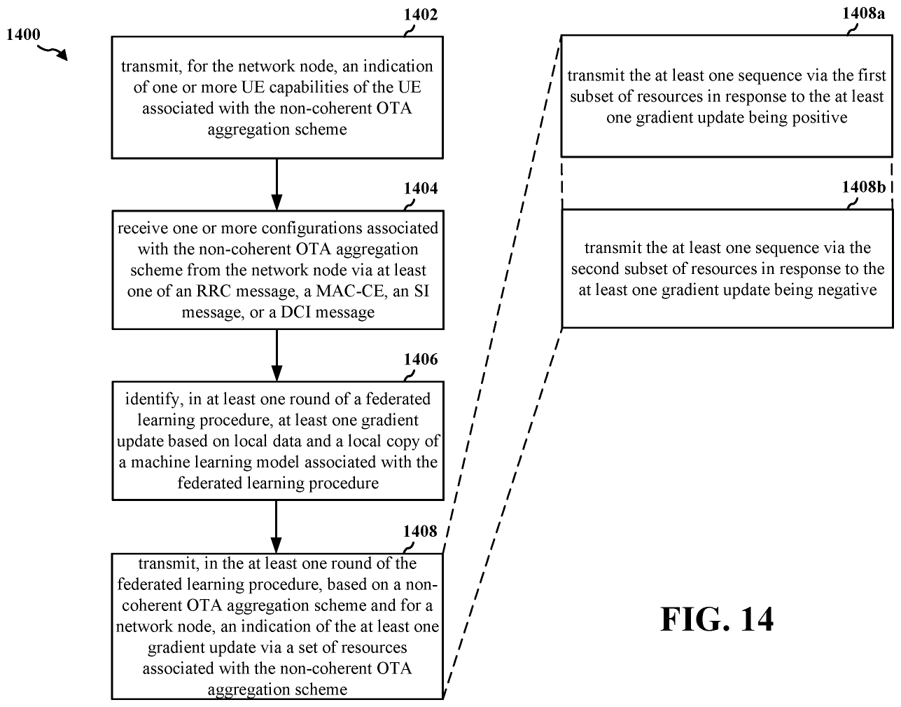

FIG. 14 is a flowchart 1400 of a method of wireless communication. The method may be performed by a UE (e.g., the UE 104/450/902/1202; the apparatus 1704). At 1406, the UE may identify, in at least one round of a federated learning procedure, at least one gradient update based on local data and a local copy of a machine learning model associated with the federated learning procedure. For example, 1406 may be performed by the component 198 in FIG. 17. Referring to FIG. 12, at 1210, the UE 1202 may identify, in at least one round of a federated learning procedure, at least one gradient update based on local data and a local copy of a machine learning model associated with the federated learning procedure.

At 1408, the UE may transmit, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update. For example, 1408 may be performed by the component 198 in FIG. 17. Referring to FIG. 12, at 1212, the UE 1202 may transmit, in the at least one round of the federated learning procedure, based on a non-coherent OTA aggregation scheme and for a network node 1204, an indication of the at least one gradient update via a set of resources associated with the non-coherent OTA aggregation scheme.

In one configuration, at 1404, the UE may receive one or more configurations associated with the non-coherent OTA aggregation scheme from the network node via at least one of an RRC message, a MAC-CE, an SI message, or a DCI message. For example, 1404 may be performed by the component 198 in FIG. 17. Referring to FIG. 12, at 1208, the UE 1202 may receive one or more configurations associated with the non-coherent OTA aggregation scheme from the network node 1204 via at least one of an RRC message, a MAC-CE, an SI message, or a DCI message.

In one configuration, referring to FIG. 12, the one or more configurations associated with the non-coherent OTA aggregation scheme at 1208 may include a quantization level configuration associated with the transmit power for the at least one sequence.

In one configuration, the transmit power for the at least one sequence may be proportional to the magnitude of the at least one gradient update.

In one configuration, the transmit power for the at least one sequence may be based at least in part on a sum of the magnitude of the at least one gradient update and an offset value.

In one configuration, the set of resources associated with the non-coherent OTA aggregation scheme may include a first subset of resources and a second subset of resources. To transmit, at 1408, the indication of the at least one gradient update, at 1408a, the UE may transmit the at least one sequence via the first subset of resources in response to the at least one gradient update being positive. For example, 1408a may be performed by the component 198 in FIG. 17. Referring to FIG. 12, at 1212a, the UE 1202 may transmit the at least one sequence via the first subset of resources in response to the at least one gradient update being positive.

Alternatively, at 1408b, the UE may transmit the at least one sequence via the second subset of resources in response to the at least one gradient update being negative. For example, 1408b may be performed by the component 198 in FIG. 17. Referring to FIG. 12, at 1212b, the UE 1202 may transmit the at least one sequence via the second subset of resources in response to the at least one gradient update being negative.

In one configuration, referring to FIG. 12, the transmit power associated with the at least one sequence may be further based on a local batch size associated with the UE 1202.

In one configuration, referring to FIG. 12, the transmit power associated with the at least one sequence may be further based on a local learning weight associated with the UE 1202.

In one configuration, referring to FIG. 12, the local learning weight associated with the UE 1202 may be based on an assignment from the network node 1204.

In one configuration, the set of resources may span a configured range in time and/or frequency.

In one configuration, at 1402, the UE may transmit, for the network node, an indication of one or more UE capabilities of the UE associated with the non-coherent OTA aggregation scheme. For example, 1402 may be performed by the component 198 in FIG. 17. Referring to FIG. 12, at 1206, the UE 1202 may transmit, for the network node 1204, an indication of one or more UE capabilities of the UE 1202 associated with the non-coherent OTA aggregation scheme.

In one configuration, the at least one sequence may be a pseudorandom sequence.

In one configuration, referring to FIG. 12, the transmit power associated with the at least one sequence may be further based on a pathloss associated with a channel for the UE 1202.

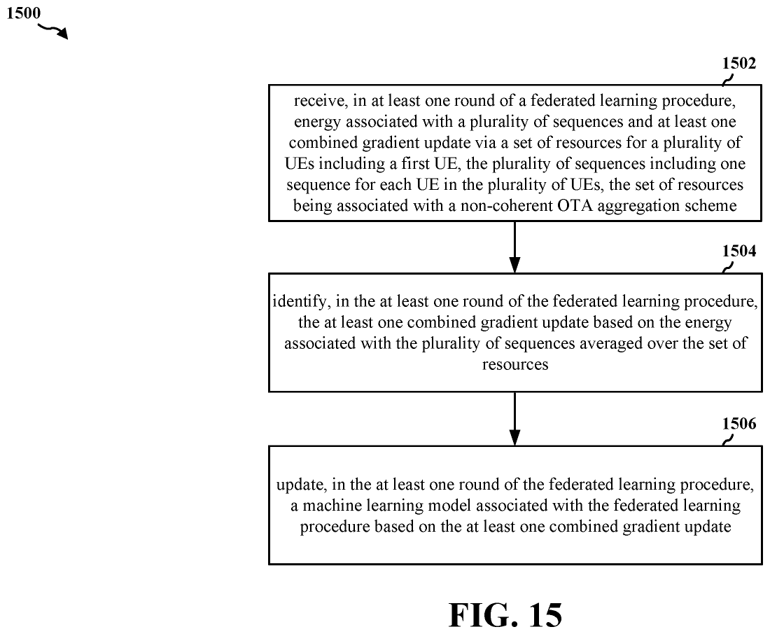

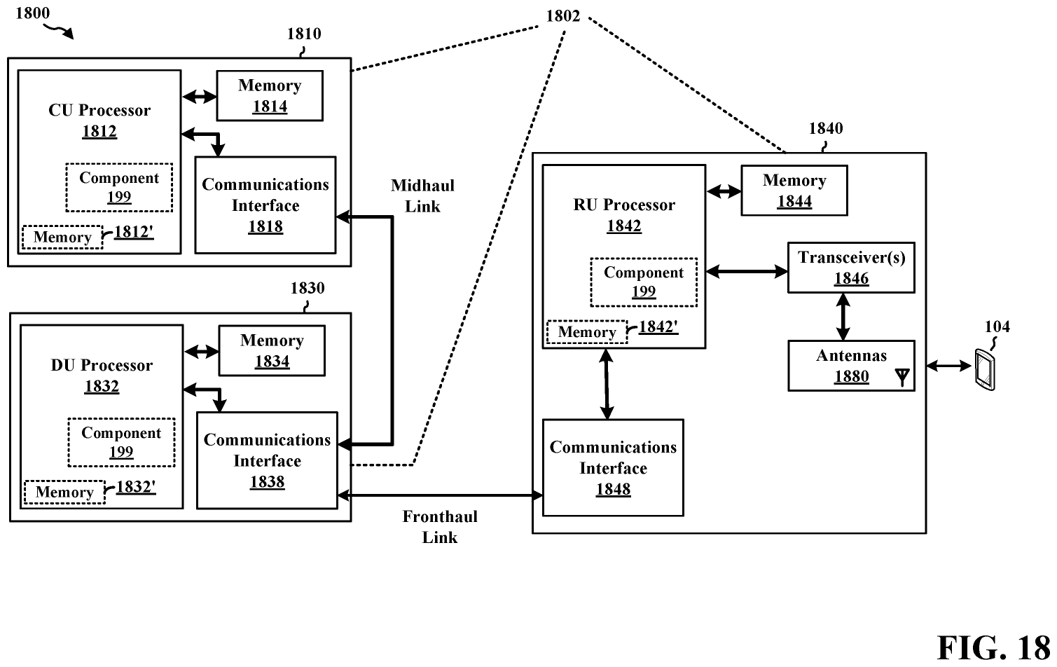

FIG. 15 is a flowchart 1500 of a method of wireless communication. The method may be performed by a network node (e.g., the base station 102/410/1204; the parameter server 912; the network entity 1702, 1802). At 1502, the network node may receive, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. For example, 1502 may be performed by the component 199 in FIG. 18. Referring to FIG. 12, at 1212, the network node 1204 may receive, in at least one round of a federated learning procedure, energy associated with a plurality of sequences and at least one combined gradient update via a set of resources for a plurality of UEs including a first UE 1202.

At 1504, the network node may identify, in the at least one round of the federated learning procedure, the at least one combined gradient update based on the energy associated with the plurality of sequences averaged over the set of resources. For example, 1504 may be performed by the component 199 in FIG. 18. Referring to FIG. 12, at 1214, the network node 1204 may identify, in the at least one round of the federated learning procedure, the at least one combined gradient update based on the energy associated with the plurality of sequences averaged over the set of resources.

At 1506, the network node may update, in the at least one round of the federated learning procedure, a machine learning model associated with the federated learning procedure based on the at least one combined gradient update. For example, 1506 may be performed by the component 199 in FIG. 18. Referring to FIG. 12, at 1216, the network node 1204 may update, in the at least one round of the federated learning procedure, a machine learning model associated with the federated learning procedure based on the at least one combined gradient update.

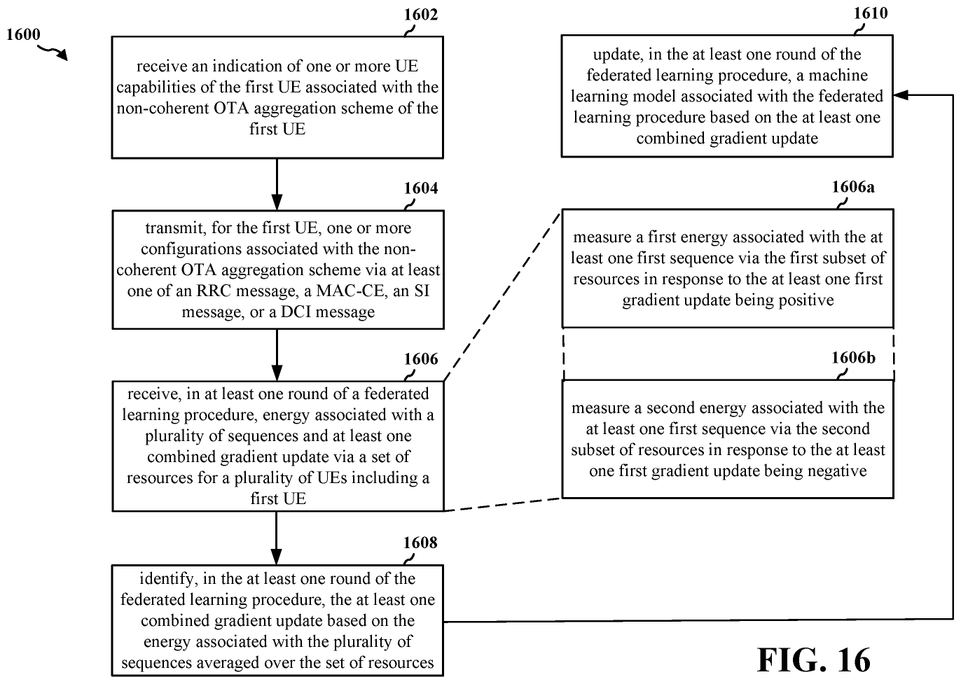

FIG. 16 is a flowchart 1600 of a method of wireless communication. The method may be performed by a network node (e.g., the base station 102/410/1204; the parameter server 912; the network entity 1702, 1802). At 1606, the network node may receive, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. For example, 1606 may be performed by the component 199 in FIG. 18. Referring to FIG. 12, at 1212, the network node 1204 may receive, in at least one round of a federated learning procedure, energy associated with a plurality of sequences and at least one combined gradient update via a set of resources for a plurality of UEs including a first UE 1202.

At 1608, the network node may identify, in the at least one round of the federated learning procedure, the at least one combined gradient update based on the energy associated with the plurality of sequences averaged over the set of resources. For example, 1608 may be performed by the component 199 in FIG. 18. Referring to FIG. 12. at 1214, the network node 1204 may identify, in the at least one round of the federated learning procedure, the at least one combined gradient update based on the energy associated with the plurality of sequences averaged over the set of resources.

At 1610, the network node may update, in the at least one round of the federated learning procedure, a machine learning model associated with the federated learning procedure based on the at least one combined gradient update. For example, 1610 may be performed by the component 199 in FIG. 18. Referring to FIG. 12, at 1216, the network node 1204 may update, in the at least one round of the federated learning procedure, a machine learning model associated with the federated learning procedure based on the at least one combined gradient update.

In one configuration, referring to FIG. 12, at least one first sequence in the plurality of sequences may be from the first UE 1202. A transmit power associated with the at least one first sequence may be based at least in part on a magnitude of at least one first gradient update of the first UE 1202.

In one configuration, at 1604, the network node may transmit, for the first UE, one or more configurations associated with the non-coherent OTA aggregation scheme via at least one of an RRC message, a MAC-CE, an SI message, or a DCI message. For example, 1604 may be performed by the component 199 in FIG. 18. Referring to FIG. 12, at 1208, the network node 1204 may transmit, for the first UE 1202, one or more configurations associated with the non-coherent OTA aggregation scheme via at least one of an RRC message, a MAC-CE, an SI message, or a DCI message.

In one configuration, referring to FIG. 12, the one or more configurations associated with the non-coherent OTA aggregation scheme at 1208 may include a quantization level configuration associated with the transmit power for the at least one first sequence.

In one configuration, the transmit power for the at least one first sequence may be proportional to the magnitude of the at least one first gradient update.

In one configuration, the transmit power associated with the at least one first sequence may be based at least in part on a sum of the magnitude of the at least one first gradient update and an offset value.

In one configuration, the set of resources associated with the non-coherent OTA aggregation scheme may include a first subset of resources and a second subset of resources. To receive, at 1606, the energy associated with the plurality of sequences and the at least one combined gradient update, at 1606a, the network node may measure a first energy associated with the at least one first sequence via the first subset of resources in response to the at least one first gradient update being positive. For example, 1606a may be performed by the component 199 in FIG. 18. Referring to FIG. 12, at 1212a, the network node 1204 may measure a first energy associated with the at least one first sequence via the first subset of resources in response to the at least one first gradient update being positive.

Alternatively, at 1606b, the network node may measure a second energy associated with the at least one first sequence via the second subset of resources in response to the at least one first gradient update being negative. For example, 1606b may be performed by the component 199 in FIG. 18. Referring to FIG. 12, at 1212b, the network node 1204 may measure a second energy associated with the at least one first sequence via the second subset of resources in response to the at least one first gradient update being negative.

In one configuration, referring to FIG. 12, the transmit power for the at least one first sequence may be further based on a local batch size associated with the first UE 1202.

In one configuration, referring to FIG. 12, the transmit power for the at least one first sequence may be further based on a local learning weight associated with the first UE 1202.

In one configuration, referring to FIG. 12, the local learning weight associated with the first UE 1202 may be based on an assignment from the network node 1204.

In one configuration, at 1602, the network node may receive an indication of one or more UE capabilities of the first UE associated with the non-coherent OTA aggregation scheme of the first UE. For example, 1602 may be performed by the component 199 in FIG. 18. Referring to FIG. 12, at 1206, the network node 1204 may receive an indication of one or more UE capabilities of the first UE 1202 associated with the non-coherent OTA aggregation scheme of the first UE 1202.

In one configuration, referring to FIG. 12, the transmit power associated with the at least one first sequence may be further based on a pathloss associated with a channel with the first UE 1202.

In one configuration, each sequence in the plurality of sequences may be a pseudorandom sequence.

In one configuration, the set of resources may span a configured range in time and/or frequency.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 450 and may include the memory 460 and/or at least one of the TX processor 468, the RX processor 456, and the controller/processor 459. In one configuration, the apparatus 1704 may be a processor chip (modem and/or application) and include just the cellular baseband processor 1724 and/or the application processor 1706, and in another configuration, the apparatus 1704 may be the entire UE (e.g., sec UE 450 of FIG. 4) and include the additional modules of the apparatus 1704.

As discussed supra, the component 198 may be configured to identify, in at least one round of a federated learning procedure, at least one gradient update based on local data and a local copy of a machine learning model associated with the federated learning procedure. The component 198 may be configured to transmit, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for identifying, in at least one round of a federated learning procedure, at least one gradient update based on local data and a local copy of a machine learning model associated with the federated learning procedure. The apparatus 1704, and in particular the cellular baseband processor 1724 and/or the application processor 1706, may include means for transmitting, in the at least one round of the federated learning procedure, based on a non-coherent OTA aggregation scheme and for a network node, an indication of the at least one gradient update via a set of resources associated with the non-coherent OTA aggregation scheme. The indication of the at least one gradient update may include at least one sequence. A transmit power associated with the at least one sequence may be based at least in part on a magnitude of the at least one gradient update.

In one configuration, the apparatus 1704, and in particular the cellular baseband processor 1724 and/or the application processor 1706, may include means for receiving one or more configurations associated with the non-coherent OTA aggregation scheme from the network node via at least one of an RRC message, a MAC-CE, an SI message, or a DCI message. In one configuration, the one or more configurations associated with the non-coherent OTA aggregation scheme may include a quantization level configuration associated with the transmit power for the at least one sequence. In one configuration, the transmit power for the at least one sequence may be proportional to the magnitude of the at least one gradient update. In one configuration, the transmit power for the at least one sequence may be based at least in part on a sum of the magnitude of the at least one gradient update and an offset value. In one configuration, the set of resources associated with the non-coherent OTA aggregation scheme may include a first subset of resources and a second subset of resources. The means for transmitting the indication of the at least one gradient update may be further configured to transmit the at least one sequence via the first subset of resources in response to the at least one gradient update being positive, or transmit the at least one sequence via the second subset of resources in response to the at least one gradient update being negative. In one configuration, the transmit power associated with the at least one sequence may be further based on a local batch size associated with the UE. In one configuration, the transmit power associated with the at least one sequence may be further based on a local learning weight associated with the UE. In one configuration, the local learning weight associated with the UE may be based on an assignment from the network node. In one configuration, the set of resources may span a configured range in time and/or frequency. In one configuration, the apparatus 1704, and in particular the cellular baseband processor 1724 and/or the application processor 1706, may include means for transmitting, for the network node, an indication of one or more UE capabilities of the UE associated with the non-coherent OTA aggregation scheme. In one configuration, the at least one sequence may be a pseudorandom sequence. In one configuration, the transmit power associated with the at least one sequence may be further based on a pathloss associated with a channel for the UE.

The means may be the component 198 of the apparatus 1704 configured to perform the functions recited by the means. As described supra, the apparatus 1704 may include the TX processor 468, the RX processor 456, and the controller/processor 459. As such, in one configuration, the means may be the TX processor 468, the RX processor 456, and/or the controller/processor 459 configured to perform the functions recited by the means.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. The component 199 may be configured to identify, in the at least one round of the federated learning procedure, the at least one combined gradient update based on the energy associated with the plurality of sequences averaged over the set of resources. The component 199 may be configured to update, in the at least one round of the federated learning procedure, a machine learning model associated with the federated learning procedure based on the at least one combined gradient update. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for receiving, in at least one round of a federated learning procedure, energy associated with a plurality of sequences and at least one combined gradient update via a set of resources for a plurality of UEs including a first UE. The plurality of sequences may include one sequence for each UE in the plurality of UEs. The set of resources may be associated with a non-coherent OTA aggregation scheme. The network entity 1802 may include means for identifying, in the at least one round of the federated learning procedure, the at least one combined gradient update based on the energy associated with the plurality of sequences averaged over the set of resources. The network entity 1802 may include means for updating, in the at least one round of the federated learning procedure, a machine learning model associated with the federated learning procedure based on the at least one combined gradient update.

In one configuration, at least one first sequence in the plurality of sequences may be from the first UE. A transmit power associated with the at least one first sequence may be based at least in part on a magnitude of at least one first gradient update of the first UE. In one configuration, the network entity 1802 may include means for transmitting, for the first UE, one or more configurations associated with the non-coherent OTA aggregation scheme via at least one of an RRC message, a MAC-CE, an SI message, or a DCI message. In one configuration, the one or more configurations associated with the non-coherent OTA aggregation scheme may include a quantization level configuration associated with the transmit power for the at least one first sequence. In one configuration, the transmit power for the at least one first sequence may be proportional to the magnitude of the at least one first gradient update. In one configuration, the transmit power associated with the at least one first sequence may be based at least in part on a sum of the magnitude of the at least one first gradient update and an offset value. In one configuration, the set of resources associated with the non-coherent OTA aggregation scheme may include a first subset of resources and a second subset of resources. The means for receiving the energy associated with the plurality of sequences and the at least one combined gradient update may be further configured to measure a first energy associated with the at least one first sequence via the first subset of resources in response to the at least one first gradient update being positive, or measure a second energy associated with the at least one first sequence via the second subset of resources in response to the at least one first gradient update being negative. In one configuration, the transmit power for the at least one first sequence may be further based on a local batch size associated with the first UE. In one configuration, the transmit power for the at least one first sequence may be further based on a local learning weight associated with the first UE. In one configuration, the local learning weight associated with the first UE may be based on an assignment from the network node. In one configuration, the network entity 1802 may include means for receiving an indication of one or more UE capabilities of the first UE associated with the non-coherent OTA aggregation scheme of the first UE. In one configuration, the transmit power associated with the at least one first sequence may be further based on a pathloss associated with a channel with the first UE. In one configuration, each sequence in the plurality of sequences may be a pseudorandom sequence. In one configuration, the set of resources may span a configured range in time and/or frequency.

The means may be the component 199 of the network entity 1802 configured to perform the functions recited by the means. As described supra, the network entity 1802 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A. multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C. or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including identifying, in at least one round of a federated learning procedure, at least one gradient update based on local data and a local copy of a machine learning model associated with the federated learning procedure; and transmitting, in the at least one round of the federated learning procedure, based on a non-coherent OTA aggregation scheme and for a network node, an indication of the at least one gradient update via a set of resources associated with the non-coherent OTA aggregation scheme, the indication of the at least one gradient update including at least one sequence, a transmit power associated with the at least one sequence being based at least in part on a magnitude of the at least one gradient update.

Aspect 2 is the method of aspect 1, further including: receiving one or more configurations associated with the non-coherent OTA aggregation scheme from the network node via at least one of an RRC message, a MAC-CE, an SI message, or a DCI message.

Aspect 3 is the method of aspect 2, where the one or more configurations associated with the non-coherent OTA aggregation scheme include a quantization level configuration associated with the transmit power for the at least one sequence.

Aspect 4 is the method of any of aspects 1 to 3, where the transmit power for the at least one sequence is proportional to the magnitude of the at least one gradient update.

Aspect 5 is the method of any of aspects 1 to 3, where the transmit power for the at least one sequence is based at least in part on a sum of the magnitude of the at least one gradient update and an offset value.

Aspect 6 is the method of any of aspects 1 to 3, where the set of resources associated with the non-coherent OTA aggregation scheme includes a first subset of resources and a second subset of resources, and transmitting the indication of the at least one gradient update further includes: transmitting the at least one sequence via the first subset of resources in response to the at least one gradient update being positive, or transmitting the at least one sequence via the second subset of resources in response to the at least one gradient update being negative.

Aspect 7 is the method of any of aspects 1 to 6, where the transmit power associated with the at least one sequence is further based on a local batch size associated with the UE.

Aspect 8 is the method of any of aspects 1 to 7, where the transmit power associated with the at least one sequence is further based on a local learning weight associated with the UE.

Aspect 9 is the method of aspect 8, where the local learning weight associated with the UE is based on an assignment from the network node.

Aspect 10 is the method of any of aspects 1 to 9, where the set of resources spans a configured range in time and/or frequency.

Aspect 11 is the method of any of aspects 1 to 10, further including: transmitting, for the network node, an indication of one or more UE capabilities of the UE associated with the non-coherent OTA aggregation scheme.

Aspect 12 is the method of any of aspects 1 to 11, where the at least one sequence is a pseudorandom sequence.

Aspect 13 is the method of any of aspects 1 to 12, where the transmit power associated with the at least one sequence is further based on a pathloss associated with a channel for the UE.

Aspect 14 is an apparatus for wireless communication at a UE including at least one processor coupled to a memory and configured to implement any of aspects 1 to 13.

In aspect 15, the apparatus of aspect 14 further includes at least one antenna coupled to the at least one processor.

In aspect 16, the apparatus of aspect 14 or 15 further includes a transceiver coupled to the at least one processor.

Aspect 17 is an apparatus for wireless communication including means for implementing any of aspects 1 to 13.

In aspect 18, the apparatus of aspect 17 further includes at least one antenna coupled to the means to perform the method of any of aspects 1 to 13.

In aspect 19, the apparatus of aspect 17 or 18 further includes a transceiver coupled to the means to perform the method of any of aspects 1 to 13.

Aspect 20 is a non-transitory computer-readable storage medium storing computer executable code, where the code, when executed, causes a processor to implement any of aspects 1 to 13.

Aspect 21 is a method of wireless communication at a network node, including receiving, in at least one round of a federated learning procedure, energy associated with a plurality of sequences and at least one combined gradient update via a set of resources for a plurality of UEs including a first UE, the plurality of sequences including one sequence for each UE in the plurality of UEs, the set of resources being associated with a non-coherent OTA aggregation scheme; identifying, in the at least one round of the federated learning procedure, the at least one combined gradient update based on the energy associated with the plurality of sequences averaged over the set of resources; and updating, in the at least one round of the federated learning procedure, a machine learning model associated with the federated learning procedure based on the at least one combined gradient update.

Aspect 22 is the method of aspect 21, wherein the received energy corresponds to combined transmissions of the plurality of sequences from the plurality of UEs.

Aspect 23 is the method of any of aspects 21 and 22, where at least one first sequence in the plurality of sequences is from the first UE, and a transmit power associated with the at least one first sequence is based at least in part on a magnitude of at least one first gradient update of the first UE.

Aspect 24 is the method of aspect 23, further including: transmitting, for the first UE, one or more configurations associated with the non-coherent OTA aggregation scheme via at least one of an RRC message, a MAC-CE, an SI message, or a DCI message.

Aspect 25 is the method of aspect 24, where the one or more configurations associated with the non-coherent OTA aggregation scheme include a quantization level configuration associated with the transmit power for the at least one first sequence.

Aspect 26 is the method of any of aspects 23 to 25, where the transmit power for the at least one first sequence is proportional to the magnitude of the at least one first gradient update.

Aspect 27 is the method of any of aspects 23 to 25, where the transmit power associated with the at least one first sequence is based at least in part on a sum of the magnitude of the at least one first gradient update and an offset value.

Aspect 28 is the method of any of aspects 23 to 25, where the set of resources associated with the non-coherent OTA aggregation scheme includes a first subset of resources and a second subset of resources, and receiving the energy associated with the plurality of sequences and the at least one combined gradient update further includes: measuring a first energy associated with the at least one first sequence via the first subset of resources in response to the at least one first gradient update being positive, or measuring a second energy associated with the at least one first sequence via the second subset of resources in response to the at least one first gradient update being negative.

Aspect 29 is the method of any of aspects 23 to 28, where the transmit power for the at least one first sequence is further based on a local batch size associated with the first UE.

Aspect 30 is the method of any of aspects 23 to 29, where the transmit power for the at least one first sequence is further based on a local learning weight associated with the first UE.

Aspect 31 is the method of aspect 30, where the local learning weight associated with the first UE is based on an assignment from the network node.

Aspect 32 is the method of any of aspects 23 to 31, further including: receiving an indication of one or more UE capabilities of the first UE associated with the non-coherent OTA aggregation scheme of the first UE.

Aspect 33 is the method of any of aspects 21 to 32, where the transmit power associated with the at least one first sequence is further based on a pathloss associated with a channel with the first UE.

Aspect 34 is the method of any of aspects 21 to 33, where each sequence in the plurality of sequences is a pseudorandom sequence.

Aspect 35 is the method of any of aspects 21 to 34, where the set of resources spans a configured range in time and/or frequency.

Aspect 36 is an apparatus for wireless communication at a network node including at least one processor coupled to a memory and configured to implement any of aspects 21 to 35.

In aspect 37, the apparatus of aspect 36 further includes at least one antenna coupled to the at least one processor.

In aspect 38, the apparatus of aspect 36 or 37 further includes a transceiver coupled to the at least one processor.

Aspect 39 is an apparatus for wireless communication including means for implementing any of aspects 21 to 35.

In aspect 40, the apparatus of aspect 39 further includes at least one antenna coupled to the means to perform the method of any of aspects 21 to 35.

In aspect 41, the apparatus of aspect 39 or 40 further includes a transceiver coupled to the means to perform the method of any of aspects 21 to 35.

Aspect 42 is a non-transitory computer-readable storage medium storing computer executable code, where the code, when executed, causes a processor to implement any of aspects 21 to 35.

What is claimed is:

1. An apparatus for wireless communication at a user equipment (UE), comprising:
a memory; and
at least one processor coupled to the memory and configured to:
identify, in at least one round of a federated learning procedure, at least one gradient update based on local data and a local copy of a machine learning model associated with the federated learning procedure; and
transmit, in the at least one round of the federated learning procedure, based on a non-coherent over-the-air (OTA) aggregation scheme and for a network node, an indication of the at least one gradient update via a set of resources associated with the non-coherent OTA aggregation scheme, the indication of the at least one gradient update comprising at least one sequence, a transmit power associated with the at least one sequence being based at least in part on a magnitude of the at least one gradient update.

2. The apparatus of claim 1, the at least one processor being further configured to:
receive one or more configurations associated with the non-coherent OTA aggregation scheme from the network node via at least one of a radio resource control (RRC) message, a medium access control—control element (MAC-CE), a system information (SI) message, or a downlink control information (DCI) message.

3. The apparatus of claim 2, wherein the one or more configurations associated with the non-coherent OTA aggregation scheme includes a quantization level configuration associated with the transmit power for the at least one sequence.

4. The apparatus of claim 1, wherein the transmit power for the at least one sequence is proportional to the magnitude of the at least one gradient update.

5. The apparatus of claim 1, wherein the transmit power for the at least one sequence is based at least in part on a sum of the magnitude of the at least one gradient update and an offset value.

6. The apparatus of claim 1, wherein the set of resources associated with the non-coherent OTA aggregation scheme includes a first subset of resources and a second subset of resources, and to transmit the indication of the at least one gradient update, the at least one processor is configured to:
transmit the at least one sequence via the first subset of resources in response to the at least one gradient update being positive, or
transmit the at least one sequence via the second subset of resources in response to the at least one gradient update being negative.

7. The apparatus of claim 1, wherein the transmit power associated with the at least one sequence is further based on a local batch size associated with the UE.

8. The apparatus of claim 1, wherein the transmit power associated with the at least one sequence is further based on a local learning weight associated with the UE.

9. The apparatus of claim 8, wherein the local learning weight associated with the UE is based on an assignment from the network node.

10. The apparatus of claim 1, wherein the set of resources spans a configured range in time and/or frequency.

11. The apparatus of claim 1, the at least one processor being further configured to:
transmit, for the network node, an additional indication of one or more UE capabilities of the UE associated with the non-coherent OTA aggregation scheme.

12. The apparatus of claim 1, wherein the at least one sequence is a pseudorandom sequence.

13. The apparatus of claim 1, wherein the transmit power associated with the at least one sequence is further based on a pathloss associated with a channel for the UE.

14. The apparatus of claim 1, further comprising at least one antenna coupled to the at least one processor, the at least one antenna being configured to transmit the indication of the at least one gradient update.

15. A method of wireless communication at a user equipment (UE), comprising:
identifying, in at least one round of a federated learning procedure, at least one gradient update based on local data and a local copy of a machine learning model associated with the federated learning procedure; and
transmitting, in the at least one round of the federated learning procedure, based on a non-coherent over-the-air (OTA) aggregation scheme and for a network node, an indication of the at least one gradient update via a set of resources associated with the non-coherent OTA aggregation scheme, the indication of the at least one gradient update comprising at least one sequence, a transmit power associated with the at least one sequence being based at least in part on a magnitude of the at least one gradient update.

16. An apparatus for wireless communication at a network node, comprising:
a memory; and
at least one processor coupled to the memory and configured to:
receive, in at least one round of a federated learning procedure, energy associated with a plurality of sequences and at least one combined gradient update via a set of resources for a plurality of user equipments (UEs) including a first UE, the plurality of sequences including one sequence for each UE in the plurality of UEs, the set of resources being associated with a non-coherent over-the-air (OTA) aggregation scheme;
identify, in the at least one round of the federated learning procedure, the at least one combined gradient update based on the energy associated with the plurality of sequences averaged over the set of resources; and
update, in the at least one round of the federated learning procedure, a machine learning model associated with the federated learning procedure based on the at least one combined gradient update.

17. The apparatus of claim 16, wherein at least one first sequence in the plurality of sequences is from the first UE, and a transmit power associated with the at least one first sequence is based at least in part on a magnitude of at least one first gradient update of the first UE.

18. The apparatus of claim 17, the at least one processor being further configured to:
transmit, for the first UE, one or more configurations associated with the non-coherent OTA aggregation scheme via at least one of a radio resource control (RRC) message, a medium access control-control element (MAC-CE), a system information (SI) message, or a downlink control information (DCI) message.

19. The apparatus of claim 18, wherein the one or more configurations associated with the non-coherent OTA aggregation scheme include a quantization level configuration associated with the transmit power for the at least one first sequence.

20. The apparatus of claim 17, wherein the transmit power for the at least one first sequence is proportional to the magnitude of the at least one first gradient update.

21. The apparatus of claim 17, wherein the transmit power associated with the at least one first sequence is based at least in part on a sum of the magnitude of the at least one first gradient update and an offset value.

22. The apparatus of claim 17, wherein the set of resources associated with the non-coherent OTA aggregation scheme includes a first subset of resources and a second subset of resources, and to receive the energy associated with the plurality of sequences and the at least one combined gradient update, the at least one processor is configured to:
measure a first energy associated with the at least one first sequence via the first subset of resources in response to the at least one first gradient update being positive, or
measure a second energy associated with the at least one first sequence via the second subset of resources in response to the at least one first gradient update being negative.

23. The apparatus of claim 17, wherein the transmit power for the at least one first sequence is further based on a local batch size associated with the first UE.

24. The apparatus of claim 17, wherein the transmit power for the at least one first sequence is further based on a local learning weight associated with the first UE.

25. The apparatus of claim 24, wherein the local learning weight associated with the first UE is based on an assignment from the network node.

26. The apparatus of claim 17, the at least one processor being further configured to:
receive an indication of one or more UE capabilities of the first UE associated with the non-coherent OTA aggregation scheme of the first UE.

27. The apparatus of claim 17, wherein the transmit power associated with the at least one first sequence is further based on a pathloss associated with a channel with the first UE.

28. The apparatus of claim 16, wherein each sequence in the plurality of sequences is a pseudorandom sequence.

29. The apparatus of claim 16, further comprising at least one antenna coupled to the at least one processor, the at least one antenna being configured to receive a wireless transmission from which the energy associated with the plurality of sequences and the at least one combined gradient update is measured, wherein the set of resources spans a configured range in time and/or frequency.

30. A method of wireless communication at a network node, comprising:
receiving, in at least one round of a federated learning procedure, energy associated with a plurality of sequences and at least one combined gradient update via a set of resources for a plurality of user equipments (UEs) including a first UE, the plurality of sequences including one sequence for each UE in the plurality of UEs, the set of resources being associated with a non-coherent over-the-air (OTA) aggregation scheme;
identifying, in the at least one round of the federated learning procedure, the at least one combined gradient update based on the energy associated with the plurality of sequences averaged over the set of resources; and
updating, in the at least one round of the federated learning procedure, a machine learning model associated with the federated learning procedure based on the at least one combined gradient update.
